(19) United States
(12) Patent Application Publication
(10) Pub. No.: US 2026/0362242 A1
(43) Pub. Date: Nov. 12, 2026

(54) HANDLING OF BUFFERED QOE DATA WHEN QOE IS DEACTIVATED IN IDLE/INACTIVE STATE UE

(71) Applicant: QUALCOMM Incorporated, San Diego, CA (US)

(72) Inventors: Jianhua LIU, Beijing (CN); Shankar KRISHNAN, Poway, CA (US)

(21) Appl. No.: 19/131,921

(22) PCT Filed: Jan. 31, 2023
(86) PCT No.: PCT/CN2023/073949

§ 371 Date: May 21, 2025

(51) Int. Cl. H04W 28/24; H04W 76/27

(52) U.S. Cl. CPC H04W 28/24; H04W 76/27

(57) ABSTRACT

A wireless communication device activates a quality of experience (QoE) configuration, accumulates QoE data in a buffer while in a radio resource control inactive (RRC_INACTIVE) state or an RRC_IDLE state subsequent to activating the QoE configuration, deactivates the QoE configuration, initiates an RRC connection setup procedure, from the RRC_IDLE state, or an RRC connection resume procedure, from the RRC_INACTIVE state, in response to both having the QoE data in the buffer and the deactivating the QoE configuration, and sends the QoE data in the buffer to a network entity following entry into an RRC_CONNECTED state at a conclusion of the RRC connection setup procedure or the RRC connection resume procedure. In one aspect, the wireless communication device stops the accumulating of the QoE data in response to determining to deactivate the QoE configuration, and stores parameters of the QoE configuration.

### TECHNICAL FIELD

The technology discussed below relates generally to wireless communication networks including user equipment (UE), and more particularly, to the handling of buffered quality of experience (QoE) data in response to QoE configuration deactivation at a UE in an idle state or an inactive state.

### INTRODUCTION

In wireless communication systems, such as those specified under standards for 5G New Radio (NR), quality of service (QOS) metrics may be based on measured key performance indicators. However, QoS metrics may not accurately reflect the quality of a user's experience with a wireless communication device in a wireless communication network. Accordingly, quality of experience (QoE) metrics are measured by user equipment and provided to operations, administration, and maintenance (OAM) entities in order to gauge users' experiences.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a wireless communication device is described. The wireless communication device includes a memory, and a processor coupled to the memory. According to one aspect, the processor is configured to activate a quality of experience (QoE) configuration, accumulate QoE data in a buffer while in a radio resource control inactive (RRC_INACTIVE) state or an RRC_IDLE state subsequent to activating the QoE configuration, deactivate the QoE configuration, initiate an RRC connection setup procedure, from the RRC_IDLE state, or an RRC connection resume procedure, from the RRC_INACTIVE state, in response to both having the QoE data in the buffer and the deactivation of the QoE configuration, and send the QoE data in the buffer to a network entity following entry into an RRC_CONNECTED state at a conclusion of the RRC connection setup procedure or the RRC connection resume procedure. In one aspect, the processor is further configured to stop the accumulating of the QoE data in response to determining to deactivate the QoE configuration, and to store parameters of the QoE configuration.

In another example, a method of wireless communication at a wireless communication device is described. The method incudes activating a quality of experience (QoE) configuration, accumulating QoE data in a buffer while in a radio resource control inactive (RRC_INACTIVE) state or an RRC_IDLE state subsequent to activating the QoE configuration, deactivating the QoE configuration, initiating an RRC connection setup procedure, from the RRC_IDLE state, or an RRC connection resume procedure, from the RRC_INACTIVE state, in response to both having the QoE data in the buffer and deactivating the QoE configuration, and sending the QoE data in the buffer to a network entity following entry into an RRC_CONNECTED state at a conclusion of the RRC connection setup procedure or the RRC connection resume procedure. In another aspect, the method of wireless communication at the wireless communication device includes stopping the accumulating of the QoE data in response to determining to deactivate the QoE configuration, and storing parameters of the QoE configuration.

In another example, an apparatus configured for wireless communication is described. According to the example, the apparatus includes means for activating a quality of experience (QoE) configuration, means for accumulating QoE data in a buffer while in a radio resource control inactive (RRC_INACTIVE) state or an RRC_IDLE state subsequent to activating the QoE configuration, means for deactivating the QoE configuration, means for initiating an RRC connection setup procedure, from the RRC_IDLE state, or an RRC connection resume procedure, from the RRC_INACTIVE state, in response to both having the QoE data in the buffer and deactivating the QoE configuration, and means for sending the QoE data in the buffer to a network entity following entry into an RRC_CONNECTED state at a conclusion of the RRC connection setup procedure or the RRC connection resume procedure. In another aspect, the apparatus configured for wireless communication also include means for stopping the accumulating of the QoE data in response to determining to deactivate the QoE configuration, and means for storing parameters of the QoE configuration.

In still another example, a non-transitory computer-readable medium having stored therein instructions executable by one or more processors of a base station is disclosed. The instructions include instructions to activate a quality of experience (QoE) configuration, instructions to accumulate QoE data in a buffer while in a radio resource control inactive (RRC_INACTIVE) state or an RRC_IDLE state subsequent to activating the QoE configuration, instructions to deactivate the QoE configuration, instructions to initiate an RRC connection setup procedure, from the RRC_IDLE state, or an RRC connection resume procedure, from the RRC_INACTIVE state, in response to both having the QoE data in the buffer and deactivating the QoE configuration, and instructions to send the QoE data in the buffer to a network entity following entry into an RRC_CONNECTED state at a conclusion of the RRC connection setup procedure or the RRC connection resume procedure. In one aspect, the instructions further include instructions to stop the accumulating of the QoE data in response to determining to deactivate the QoE configuration, and instructions to store parameters of the QoE configuration.

These and other aspects of the disclosure will become more fully understood upon a review of the detailed description, which follows. Other aspects, features, and embodiments of the present disclosure will become apparent to those of ordinary skill in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while example embodiments may be discussed below as device, system, or method embodiments it should be understood that such example embodiments can be implemented in various devices, systems, and methods.

### BRIEF DESCRIPTION OF THE DRAWINGS

FIG. 1 is a schematic illustration of a wireless communication system according to some aspects of the disclosure.

FIG. 2 is a schematic illustration of an example of a radio access network (RAN) according to some aspects of the disclosure.

FIG. 3 is a schematic illustration of an example disaggregated base station architecture according to some aspects of the disclosure.

FIG. 4 is an expanded view of an exemplary subframe, showing an orthogonal frequency divisional multiplexing (OFDM) resource grid according to some aspects of the disclosure.

FIG. 5 is a schematic depiction of a 5G user plane protocol stack and a 5G control plane protocol stack according to some aspects of the disclosure.

FIG. 6 is a schematic depiction of state transitions among three radio resource control states in 5G according to some aspects of the disclosure.

FIG. 7 is a call flow diagram illustrating quality of experience measurement collection activation according to some aspects of the disclosure.

FIG. 8 is a call flow diagram illustrating quality of experience measurement reporting according to some aspects of the disclosure.

FIG. 9 is a call flow diagram illustrating quality of experience measurement collection deactivation or release according to some aspects of the disclosure.

FIG. 10 is a call flow diagram illustrating the accumulation of quality of experience data in a buffer during an RRC_INACTIVE and/or an RRC_IDLE state and the reporting of the buffered quality of experience data in response to receiving a quality of experience measurement collection deactivation indication according to some aspects of the disclosure.

FIG. 11 is a block diagram illustrating an example of a hardware implementation of a wireless communication device employing a processing system according to some aspects of the disclosure.

FIG. 12 is a flow chart illustrating an example process of wireless communication at a wireless communication device according to some aspects of the disclosure.

FIG. 13 is a flow chart illustrating an example process of wireless communication at a wireless communication device according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some examples, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or user equipment (UE)), end-user devices, etc. of varying sizes, shapes, and constitution.

Described herein are techniques directed toward avoidance of a loss of QoE data in response to the deactivation of a QoE configuration at a UE. The QoE data may be collected at the UE after a QoE configuration is activated and while the UE is in an RRC_INACTIVE state or an RRC_IDLE state. The QoE data may be stored in a QoE data buffer of the UE. According to some aspects, the UE may initiate an RRC configuration setup procedure or an RRC connection resume procedure when the QoE configuration is deactivated and in response to QoE data being accumulated in and buffered in the QoE data buffer of the UE. Accordingly, upon being instructed to deactivate the QoE configuration or otherwise determining that deactivation is required and determining that QoE data is stored in the QoE buffer, the UE may initiate an RRC connection setup procedure (if the UE is in the RRC_IDLE state) or an RRC connection resume procedure (if the UE is in the RRC_INACTIVE state) and may transmit the buffered QoE data to, for example, an operations, administration, and maintenance (OAM) entity via a network entity (e.g., an NG-RAN) once the UE is in the RRC_CONNECTED state. According to some aspects, in response to being instructed to deactivate the QoE configuration or otherwise determining that deactivation is required, the UE may store buffered QoE data and store the deactivated QoE configuration but stop further QoE measurement collection. Storage of the deactivated QoE configuration may reduce the time needed to re-activate the QoE configuration if re-activation is necessitated.

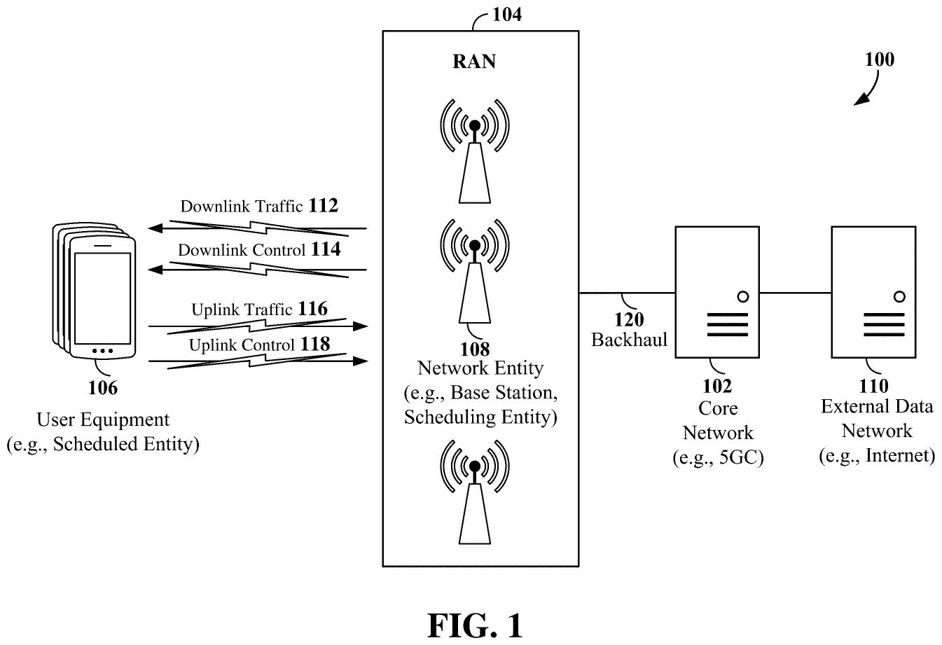

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of network entities 108 (e.g., base stations, gNBs, TRPs, scheduling entities). Broadly, a network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In some examples, a network entity may be a network element in a radio access network responsible for radio transmission and reception in one or more cells to or from a UE. In different technologies, standards, or contexts, a network entity may variously be referred to by those skilled in the art as a base station, a base transceiver station (BTS), a radio base station, a radio transceiver, a transceiver function, a basic service set (BSS), an extended service set (ESS), an access point (AP), a network access node, a Node B (NB), an eNode B (eNB), a gNode B (gNB), a transmission and reception point (TRP), a scheduling entity, or some other suitable terminology. In some examples, a network entity 108 may include two or more TRPs that may be collocated or non-collocated. Each TRP may communicate on the same or different carrier frequency within the same or different frequency band. In examples where the RAN 104 operates according to both the LTE and 5G NR standards, one of the network entities may be an LTE network entity, while another network entity may be a 5G NR network entity.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, a scheduled entity, or some other suitable terminology. A UE (e.g., UE 106) may be an apparatus (e.g., a mobile apparatus) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF-chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of Things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a network entity (e.g., network entity 108) to one or more UEs (e.g., similar to UE 106) may be referred to as downlink (DL) transmission. In accordance with certain aspects of the present disclosure, the term downlink may refer to a point-to-multipoint transmission originating at a network entity (e.g., network entity 108). Another way to describe this scheme may be to use the term broadcast channel multiplexing. Transmissions from a UE (e.g., UE 106) to a network entity (e.g., network entity 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, where a scheduling entity (e.g., a network entity 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by a scheduling entity (e.g., network entity 108).

Network entities are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, a network entity 108 may broadcast downlink traffic 112 to one or more UE's 106 (e.g., one or more scheduled entities). Broadly, the network entity 108 is a node or device responsible for scheduling traffic in a wireless communication network, including the downlink traffic 112 and, in some examples, uplink traffic 116 from one or more UEs 106 (e.g., one or more scheduled entities) to the network entity 108. On the other hand, the UE 106 (e.g., the scheduled entity) is a node or device that receives downlink control information 114, including but not limited to scheduling information (e.g., a grant), synchronization or timing information, or other control information from another entity in the wireless communication network such as the network entity 108. The UE 106 may further transmit uplink control information 118, including but not limited to a scheduling request or feedback information, or other control information to the network entity 108.

In addition, the uplink control information 118 and/or downlink control information 114 and/or uplink traffic 116 and/or downlink traffic 112 may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per subcarrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, a network entity 108 may include a backhaul interface for communication with a backhaul portion 120 of the wireless communication system 100. The backhaul portion 120 may provide a link between a network entity 108 and the core network 102. Further, in some examples, a backhaul network may provide interconnection between the respective network entities 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5G core (5GC)). In other examples, the core network 102 may be configured according to a 4G evolved packet core (EPC), or any other suitable standard or configuration.

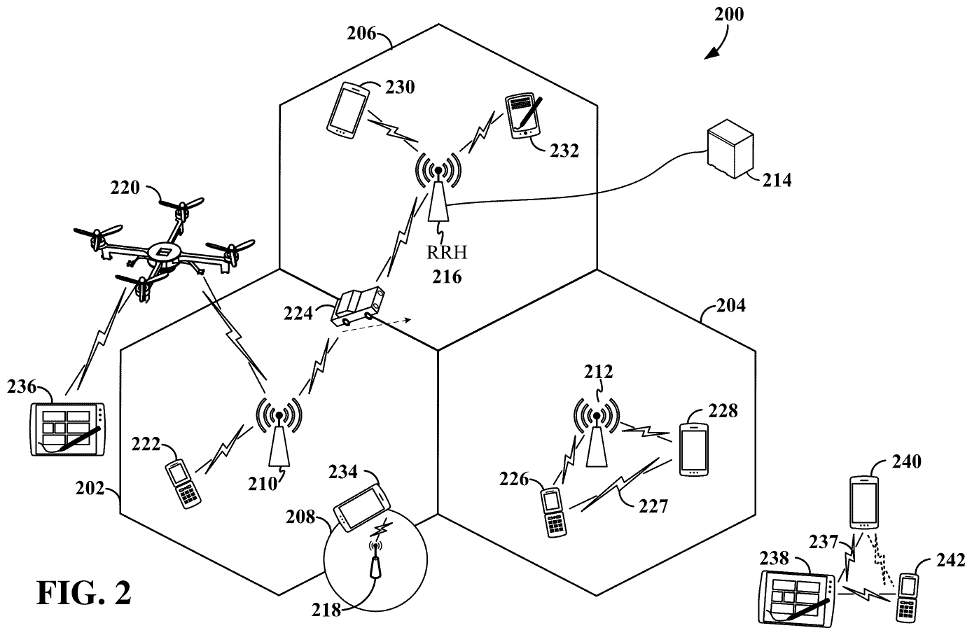

Referring now to FIG. 2, as an illustrative example without limitation, a schematic illustration of an example of a radio access network (RAN) 200 according to some aspects of the disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or network entity. FIG. 2 illustrates cells 202, 204, 206, and 208, each of which may include one or more sectors (not shown). A sector is a sub-area of a cell. All sectors within one cell are served by the same network entity. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various network entity arrangements can be utilized. For example, in FIG. 2, two base stations, base station 210 and base station 212 are shown in cells 202 and 204. A third base station, base station 214 is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a small cell, a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of network entities (e.g., base stations, gNBs, TRPs, scheduling entities) and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the network entity 108 described above and illustrated in FIG. 1.

FIG. 2 further includes an unmanned aerial vehicle (UAV) 220, which may be a drone (e.g., a quadcopter, octocopter, remotely piloted vehicle, etc.). The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210, UEs 226 and 228 may be in communication with base station 212, UEs 230 and 232 may be in communication with base station 214 by way of RRH 216, UE 234 may be in communication with base station 218, and UE 236 may be in communication with mobile base station 220. In some examples, the UEs 222, 224, 226, 228, 230, 232, 234, 236, 238, 240, and/or 242 may be the same as or similar to the UE 106 described above and illustrated in FIG. 1. In some examples, the UAV 220 can be a mobile network entity and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of network entities and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, where technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz 7.125 GHZ) and FR2 (24.25 GHz-52.6 GHz). It should be understood that although a portion of FR 1 is greater than 6 GHz, FR 1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into the mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHZ), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR 1, or may include mid-band frequencies. Further, unless specifically stated otherwise, it should be understood that the term “millimeter wave” or the like if used herein may broadly represent frequencies that may be within FR2, FR4, FR4-a or FR4-1, and/or FR5, or may be within the EHF band.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different subbands of the carrier bandwidth. This type of full-duplex communication may be referred to herein as subband full-duplex (SBFD), also known as flexible duplex.

Deployment of communication systems, such as 5G new radio (NR) systems, may be arranged in multiple manners with various components or constituent parts. In a 5G NR system, or network, a network entity, a mobility element of a network, a radio access network (RAN) node, a core network entity, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

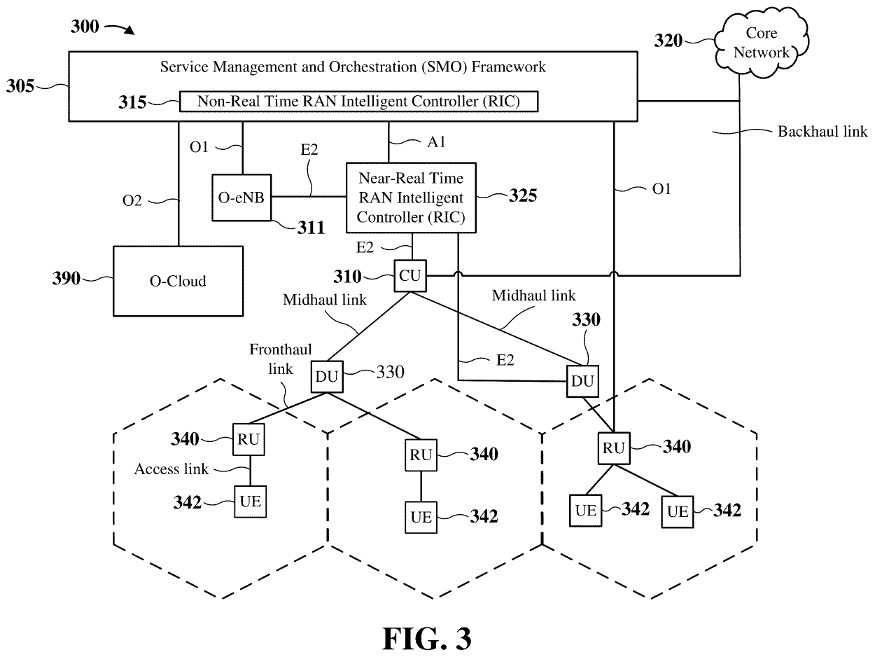

FIG. 3 is a schematic illustration of an example disaggregated base station 300 architecture according to some aspects of the disclosure. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 342 via one or more radio frequency (RF) access links. In some implementations, the UE 342 may be simultaneously served by multiple RUs 340. UE 342 may be the same or similar to any of the UEs or scheduled entities illustrated and described in connection with FIG. 1 and FIG. 2, for example.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the El interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation, and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 342. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as Al policies).

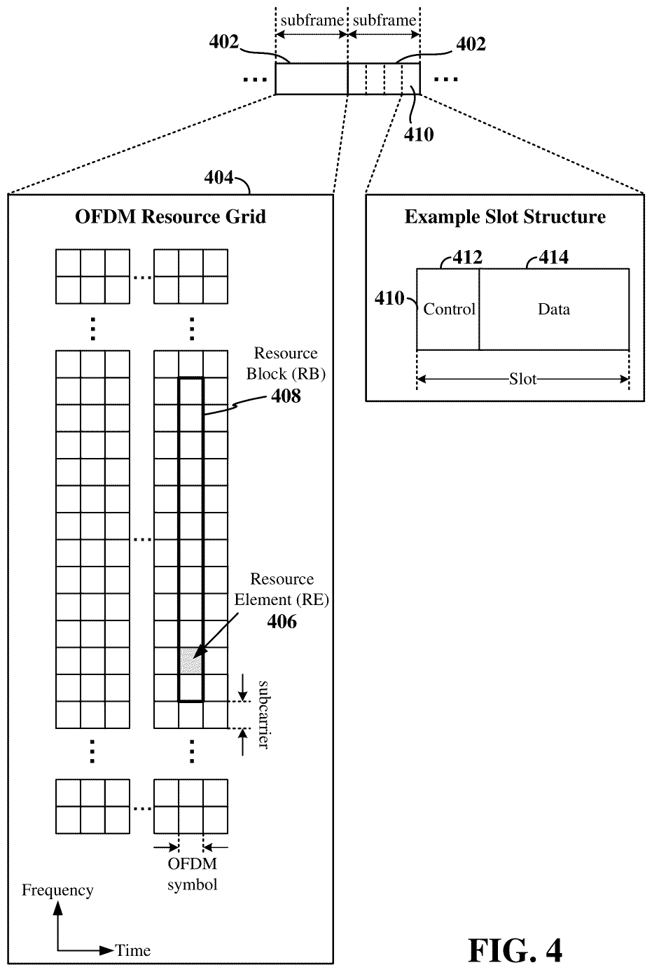

Various aspects of the present disclosure will be described with reference to an OFDM waveform, schematically illustrated in FIG. 4. It should be understood by those of ordinary skill in the art that the various aspects of the present disclosure may be applied to an SC-FDMA waveform in substantially the same way as described hereinbelow. That is, while some examples of the present disclosure may focus on an OFDM link for clarity, it should be understood that the same principles may be applied as well to SC-FDMA waveforms.

Referring now to FIG. 4, an expanded view of an exemplary subframe 402 is illustrated, showing an OFDM resource grid according to some aspects of the disclosure. However, as those skilled in the art will readily appreciate, the physical (PHY) transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. That is, in a multiple-input-multiple-output (MIMO) implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), subband, or bandwidth part (BWP). A set of subbands or BWPs may span the entire bandwidth. Scheduling of scheduled entities (e.g., UEs) for downlink, uplink, or sidelink transmissions may involve scheduling one or more resource elements 406 within one or more subbands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a network entity (e.g., a base station, a gNB, a TRP, a scheduling entity), or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional example may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels, and the data region 414 may carry data channels. Of course, a slot may contain all DL, all UL, or at least one DL portion and at least one UL portion. The structure illustrated in FIG. 4 is merely exemplary in nature, and different slot structures may be utilized, and may include one or more of each of the control region(s) and data region(s).

Although not illustrated in FIG. 4, the various REs 406 within a RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a network entity, UE, or other similar device) to other devices. Here, a broadcast communication is delivered to all devices, whereas a multicast or groupcast communication is delivered to multiple intended recipient devices. A unicast communication may refer to a point-to-point transmission by one device to a single other device.

In an example of cellular communication over a cellular carrier via a Uu interface, for a DL transmission, the scheduling entity (e.g., a network entity) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, where the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The network entity may further allocate one or more REs 406 (e.g., in the control region 412 or the data region 414) to carry other DL signals, such as a demodulation reference signal (DMRS), a phase-tracking reference signal (PT-RS), a channel state information (CSI) reference signal (CSI-RS), and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESETO), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A network entity may transmit other system information (OSI) as well.

In an UL transmission, the scheduled entity (e.g., UE) may utilize one or more REs 406 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling Qualcomm request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data. Such data may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a proximity service (ProSe) PC5 interface, the control region 412 of the slot 410 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 414 of the slot 410 may include a physical sidelink shared channel (PSSCH) including sidelink data transmitted by the initiating (transmitting) sidelink device within resources reserved over the sidelink carrier by the transmitting sidelink device via the SCI. Other information may further be transmitted over various REs 406 within slot 410. For example, HARQ feedback information may be transmitted in a physical sidelink feedback channel (PSFCH) within the slot 410 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 410.

These physical channels described above are generally multiplexed and mapped to transport channels for handling at the medium access control (MAC) layer. Transport channels carry blocks of information called transport blocks (TB). The transport block size (TBS), which may correspond to a number of bits of information (e.g., a quantity of the bits of information), may be a controlled parameter, based on the modulation and coding scheme (MCS) and the number of RBs in a given transmission.

The channels or carriers described above in connection with FIGS. 1-4 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

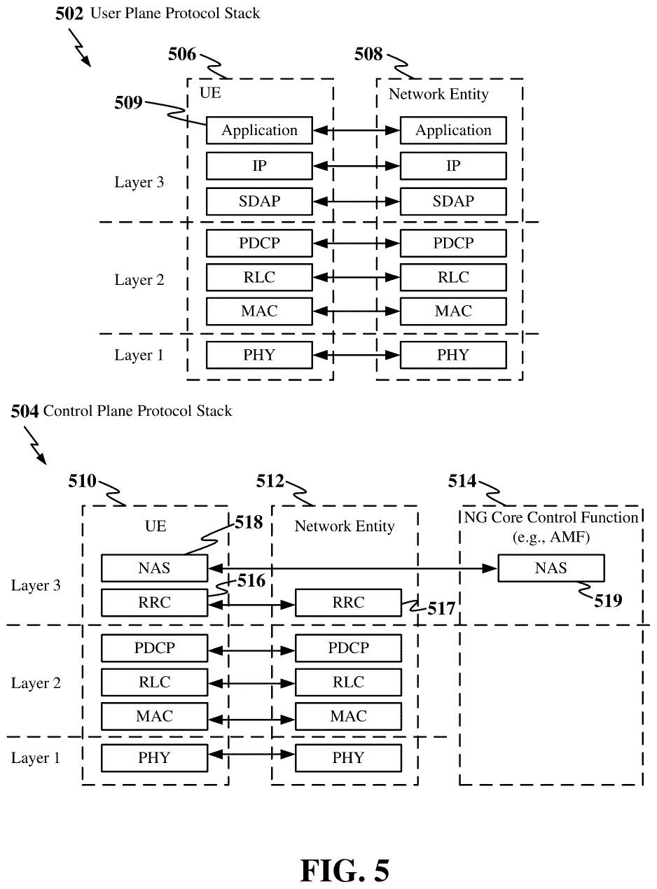

FIG. 5 is a schematic depiction of a 5G user plane protocol stack 502 and a 5G control plane protocol stack 504 according to some aspects of the disclosure. The user plane protocol stack 502 depicts a UE user plane protocol stack 506 and a network entity user plane protocol stack 508 (e.g., the network entity may be a gNB, an NG-RAN). The UE user plane protocol stack 506 and the network entity user plane protocol stack 508 both include the following layers: physical (PHY), medium access control (MAC), radio link control (RLC), packet data convergence protocol (PDCP), service data adaptation protocol (SDAP), internet protocol (IP), and application layer 509. The functions of each of the layers are well known and will not be presented herein for the sake of brevity. Various layers are sometimes individually or collectively referred to as Layer 1, Layer 2, Layer 3. For example, the PHY layer is often referred to as Layer 1, and the MAC, RLC, and PDCP layers are often referred to as Layer 2. The SDAP layer may be referred to as Layer 3.

The control plane protocol stack 504 depicts a UE control plane protocol stack 510, a network entity control plane protocol stack 512, and a Next Generation (NG) core control function protocol stack 514 (where the core control function may be, for example, an access and mobility management function (AMF)). The UE control plane protocol stack 510 includes the following layers: physical (PHY), medium access control (MAC), radio link control (RLC), packet data convergence protocol (PDCP), radio resource control (RRC) layer 516, and non-access stratum (NAS) layer 518. The network entity control plane protocol stack 512 includes the following layers: physical (PHY), medium access control (MAC), radio link control (RLC), packet data convergence protocol (PDCP), and radio resource control (RRC) layer 517. The NG core control function protocol stack 514 includes a non-access stratum (NAS) 519 layer. As with the user plane protocol stack 502, the functions of each of the layers of the control plane protocol stack 504 are well-known and will not be presented herein for the sake of brevity. Similar to the user plane protocol stack 502, the PHY layer is referred to as Layer 1, and the MAC, RLC, and PDCP layers are referred to as Layer 2. The RRC and NAS layers may be referred to as Layer 3. As depicted in FIG. 5, the RRC layer 516, 517 exists in the control plane protocol stack 504. The UE RRC layer 516 of the UE control plane protocol stack 510 interfaces with the network entity RRC layer 517 of the network entity control plane protocol stack 512. The interface may be a Uu interface (not shown). The UE NAS layer 518 interfaces with the NG Core NAS layer 519. The RRC and NAS layers are not in the user plane protocol stack 502. Operations within the RRC layer are governed by a current state of the UE RRC layer 516. The state of the UE RRC layer 516 may transition between RRC_CONNECTED, RRC_INACTIVE, and RRC_IDLE.

Non-access-stratum relates to protocols between a UE and a core network that are not terminated in a radio access network (RAN), here exemplified as the network entity. As illustrated in the control plane protocol stack 504 of FIG. 5, NAS messages may be passed transparently through the RAN (through the network entity control plane protocol stack 512). The NAS layer may be used to establish communication sessions and maintain continuous communications with the UE as the UE moves. A different stratum, referred to as the access-stratum (AS), may be responsible for carrying information over the wireless portion of a network between the UE and the network entity. While the NAS may be used for dialogue between the UE and the NG Core (e.g., Core Network 102 as shown and described in connection with FIG. 1), the AS may be used for dialogue between the UE and the network entity (e.g., the RAN, the gNB).

The access stratum may be thought of as a functional grouping that includes the parts in the network entity infrastructure and in the UE and the protocols between these parts that are related to the access technique (i.e., the way the specific physical media between the UE and the network entity is used to carry information). The access stratum provides services related to the transmission of data over the radio interface and the management of the radio interface. An access stratum connection may refer to a peer-to-peer access stratum connection between the UE and the network entity (e.g., an NG-RAN, a gNB) for 3GPP access. As used herein, the access stratum connection corresponds to an RRC connection via a Uu reference point or interface (not shown). Other access stratum connections are within the scope of the disclosure.

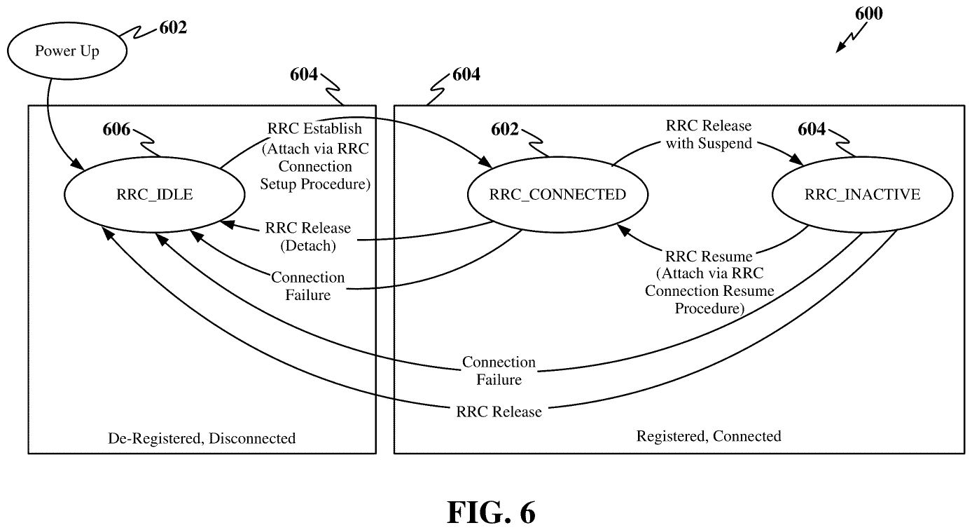

FIG. 6 is a schematic depiction of state transitions among three radio resource control (RRC) states 600 in 5G according to some aspects of the disclosure. In 5G NR, RRC has three states: RRC_CONNECTED 602, RRC_INACTIVE 604, and RRC_IDLE 606. Functions are associated with each UE RRC state. For example, while in the RRC_IDLE 606 state, the UE may be configured for discontinuous reception (DRX), which may be a function configured to the UE by NAS. In RRC_IDLE 606, the functionality of the UE may include paging (initiated by the core network). In the RRC_IDLE 606 state, the UE may have a Core Network ID (CN ID) that uniquely identifies the UE within a tracking area. However, in the RRC_IDLE 606 state, there is no RRC context associated with the UE that is stored in the network entity.

In the RRC_INACTIVE 604 state, the UE may also be configured for DRX; however, in the RRC_INACTIVE 604 state, DRX may be configured by NAS or by the network entity. Similarly, in the RRC_INACTIVE 604 state, the functionality of the UE may include paging; however, in the RRC_INACTIVE 604 state, paging may be initiated by the core network or by the network entity. In the RRC_INACTIVE 604 state, the network entity may identify a RAN-based notification area (RNA) to which the UE belongs. In the RRC_INACTIVE 604 state, a UE AS context is stored at both the UE and the network entity, and a 5GC to NG-RAN connection in both the control and user planes is established for the UE. In general, in both the RRC_IDLE 606 state and the RRC_INACTIVE 604 state, UE controlled mobility is based on network configuration (e.g., call reselection).

In the RRC_CONNECTED 602 state, there is network controlled mobility within NR and to/from eUTRAN. DRX may be configured by the network entity in the RRC_CONNECTED state. The UE may make and report neighbor cell measurements, the network may transmit and/or receive data to/from the UE, and the NG-RAN may identify a cell to which the UE belongs. In general, in both the RRC_INACTIVE 604 state and the RRC_CONNECTED 602 state, the UE and the NG-RAN have a UE AS context (e.g., RRC context) stored, and a 5GC to NG-RAN connection in both the control and user planes is established for the UE. In summary, in the RRC_INACTIVE and RRC_CONNECTED states, the UE and NG-RAN store an AS inactive context and AS context respectively. In the RRC_IDLE state, the UE may be registered with the Core Network (CN), but no AS context is stored.

The UE may transition between the three RRC states. For example, an RRC_IDLE to RRC_CONNECTED transition may happen via an RRC Connection Setup procedure, which may include three messages: RRCSetupRequest (UE initiated), RRCSetup, and RRCSetupComplete (not shown).

The RRC_CONNECTED to RRC_IDLE transition may be via an RRC Connection Release procedure with a network-initiated RRCRelease message (not shown). Upper layers in the UE may also request a release. RRC connection is also released due to connection failures, such as a radio link failure, a handover failure, or a cell not meeting cell selection criterion.

The RRC_CONNECTED to RRC_INACTIVE transition may be network initiated. The transition may be entered via an RRCRelease message with a suspendConfig information element (IE). When a UE uses a Dual Active Protocol Stack (DAPS) bearer or is redirected to an inter-RAT carrier frequency, the suspendConfig IE may not be configured.

The network may trigger the RRC_INACTIVE to RRC_CONNECTED transition via RAN paging. A paged UE may start with an RRC Connection Resume procedure including three messages: RRCResumeRequest, RRCResume (or RRCSetup), RRCResumeComplete (or RRCSetupComplete) (not shown). UE may also initiate this procedure for uplink transfer, including RNA update.

The RRC_INACTIVE to RRC_IDLE transition may occur when the network responds to an RRCResumeRequest with an RRCRelease. Alternatively, the UE may be instructed or expected to remain in an RRC_INACTIVE for a given amount of time. According to some aspects, the RRC_INACTIVE state may be a UE RRC's way of implementing an always-on radio connection with the network.

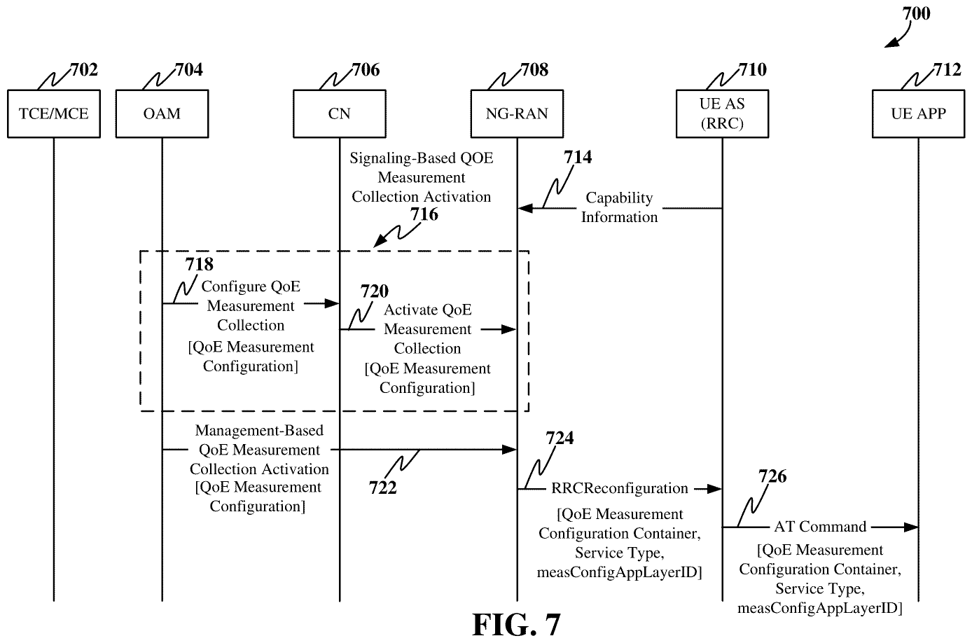

FIG. 7 is a call flow diagram 700 illustrating QoE Measurement Collection (QMC) activation according to some aspects of the disclosure. The call flow diagram 700 depicts a trace collection entity/measurement collection entity (TCE/MCE) 702, an OAM 704, a CN 706, an NG-RAN 708, a UE access stratum (UE AS) 710 (e.g., a UE RRC layer), and a UE application layer (UE App) 712. The UE, via the UE AS 710, may initially convey UE capability information 714 to the NG-RAN 708.

Quality of Experience (QoE) is a metric that characterizes the human experience of the service delivered over the network to an end user's device (e.g., the UE, the wireless communication device). QoE may be enhanced to support new service types like augmented reality (AR), mixed reality (MR), extended reality (XR), multicast and broadcast service (MBS), and other service types that may be considered now or in the future in connection with, for example, video and streaming delivery of immersive media, including but not limited to the delivery of such services in high mobility scenarios such as, but not limited to, high-speed trains. According to some aspects, QoE may be enhanced to support the collection of QoE data when a UE is in an RRC_INACTIVE or an RRC_IDLE state. Such an enhancement may be used, for example, in connection with a multicast and broadcast service (MBS), or at least for the broadcast service (where the broadcast continues even though the UE is in the RRC_INACTIVE or the RRC_IDLE state).

In QoE measurements, an application layer QoE Measurement Configuration may be received from an operations, administration, and maintenance (OAM) entity or the core network (CN). The application layer QoE Measurement Configuration may be encapsulated in a first transparent container, which may be forwarded to the UE App 712 layer (e.g., UE application layer 509 as shown and described in connection with FIG. 5) via a downlink RRC message (e.g., in an RRCReconfiguration message). Although the first transparent container is forwarded through the RRC layer, the RRC layer does not unpack the container. In other words, the downlink message within the container is transparent to the RRC layer.

Thereafter, QoE measurements may be configured and activated, for example, in the application layer. Application layer measurements (e.g., the QoE measurements) received from higher layers of the UE may subsequently be encapsulated in a second transparent container (e.g., a transparent report container) and sent from the UE application layer to the CN 706 or the OAM 704 via an uplink RRC message. Although the second transparent container is forwarded through the RRC layer (e.g., through UE AS 710), the RRC layer does not unpack the container. In other words, the uplink message within the second transparent container is transparent to the RRC layer. According to some aspects, QoE reports may be sent via a signaling radio bearer (SRB) that may be separate from other SRBs because QoE reporting may have a lower priority than other SRB transmissions.

A QoE Measurement Collection feature may enable the collection of application layer measurements from the UE. According to some aspects, supported service types include, but are not limited to: QoE Measurement Collection for streaming services; QoE Measurement Collection for Multimedia Telephony Service for IP Multimedia Subsystem (MTSI) services; and QoE Measurement Collection for Virtual Reality (VR) services. As described above, enhancements to QoE measurements may lead to the inclusion of other services.

The QoE Measurement Collection feature may be activated in the NG-RAN 708 either by signaling from the OAM 704 via the CN 706 (i.e., Signaling-based 716 QoE Measurement Collection Activation), or by direct configuration from the OAM 704 (i.e., Management-based 722 QoE Measurement Collection Activation). One or more QoE measurement collection jobs may be activated at a UE per service type. A QoE Reference uniquely identifies each QoE Measurement Configuration.

For Signaling-based 716 QoE Measurement Collection Activation, the OAM 704 may initiate the QoE measurement activation for a specific UE via the CN 706. For example, the OAM 704 may send a Configure QoE Measurement Collection 718 message to the CN 706. The Configure QoE Measurement Collection 718 message may carry QoE Measurement Configuration information.

In response to receiving the Configure QoE Measurement Collection 718 message, the CN 706 may send an Activate QoE Measurement Collection 720 message carrying the QoE Measurement Configuration data to the NG-RAN 708. Application layer QoE Measurement Configuration information received by the NG-RAN 708 from the OAM 704 or the CN 706 may be encapsulated in a transparent container, which is forwarded to a UE as Application layer configuration in the RRCReconfiguration 724 message (there can be multiple configurations in the same message).

For Management-based 722 QoE Measurement Collection Activation, the OAM 704 may send one or more QoE Measurement Configurations to the NG-RAN 708. The QoE Measurement Configuration for Management-based 722 QoE Measurement Collection Activation may also include an application layer QoE Measurement Configuration list and the corresponding information for QoE Measurement Collection. Each application layer QoE Measurement Configuration may be encapsulated in a transparent container. For example, the NG-RAN 708 may select one or more UEs that meet the required QoE measurement capability, area scope, and slice scope.

The NG-RAN 708 may receive (from Signaling-based 716 QOE Measurement Collection Activation or Management-based 722 QoE Measurement Collection Activation) one or more QoE Measurement Configurations through UE-associated signaling. The QoE Measurement Configuration information may include an application layer QoE Measurement Configuration list and corresponding information for QoE Measurement Collection. The QoE Measurement Configuration information, including the application layer QoE Measurement Configuration list and corresponding information for QoE Measurement Collection, may be received by the NG-RAN 708 in a transparent container (e.g., the QoE Measurement Configuration Container, the first transparent container as described above). The QoE Measurement Configuration List in the transparent QMC configuration container (e.g., an extensible markup language (XML) file) may include the following information: QoE Reference, service type, MCE IP address, slice scope, area scope, Minimization of Drive Test (MDT) alignment information, and an indication of available RAN visible QoE metrics.

In response to receiving the Activate QoE Measurement Collection 720 message, the NG-RAN 708 may forward the corresponding QoE Measurement Configuration(s) to the UE AS 710 (e.g., the UE RRC layer) in a downlink RRC message (e.g., an RRCReconfiguration 724 message). The RRCReconfiguration 724 message may include the QoE Measurement Configuration Container (e.g., an XML file), service type, and measConfigAppLayerID, for example. The mapping between measConfigAppLayerID and QoE Reference may be maintained in the NG-RAN 708.

In response to receiving the RRCReconfiguration 724 message, the UE AS 710 (e.g., the UE RRC layer) may send an attention (AT) command 726 to the UE app layer 712. The AT command 726 may include the QoE Measurement Configuration Container, service type, and measConfigAppLayerID, for example.

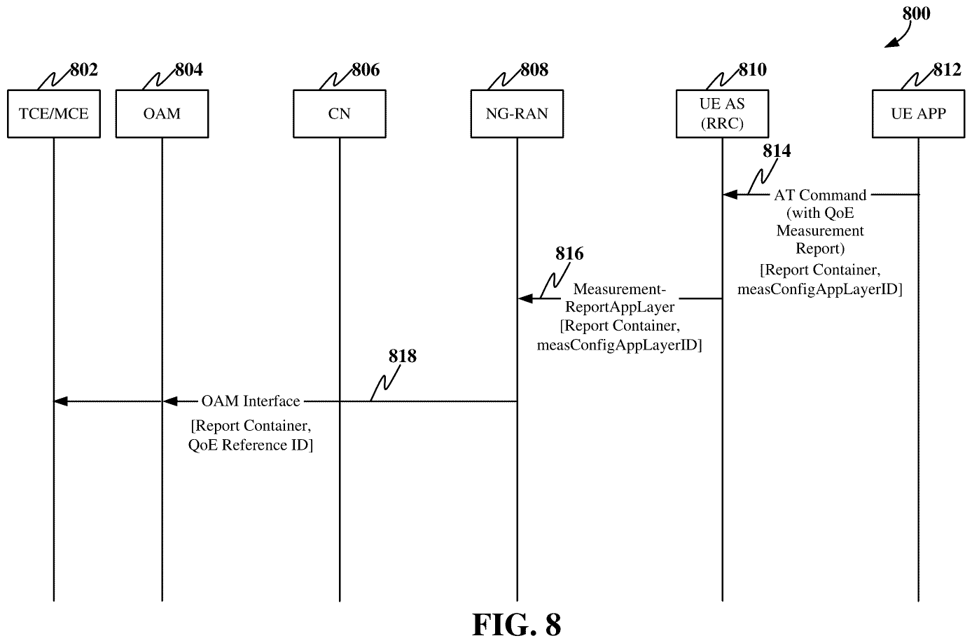

FIG. 8 is a call flow diagram 800 illustrating QoE measurement reporting according to some aspects of the disclosure. As in FIG. 7, the call flow diagram 800 of FIG. 8 includes a TCE/MCE 802, an OAM 804, a CN 806, an NG-RAN 808, a UE AS 810 (e.g., a UE RRC layer), and a UE App layer 812. The UE App layer 812 may handle the QoE Measurement Collection. Application layer measurement reports received from UE's higher layer may be encapsulated in a transparent container in a MeasurementReportAppLayer RRC message over SRB4, for example. The UE may send multiple application layer measurement reports to the gNB in one MeasurementReportAppLayer message. A measConfigAppLayerId may be used to identify one application layer measurement configuration and report between the NG-RAN 808 and the UE (e.g., the UE AS 810, the UE RRC layer). The application layer measurement report may be forwarded to OAM together with the QoE Reference.

In order to allow the transmission of application layer measurement reports which exceed the maximum PDCP SDU size, segmentation of the MeasurementReportAppLayer message may be enabled by the gNB. Segmentation may allow for the transmission of application layer measurement reports which exceed the maximum PDCP SDU size. An existing RRC segmentation mechanism may be applied.

A measConfigAppLayerId conveyed in the RRC signaling may be used to identify the application layer measurement configuration and report between the gNB and the UE. The RRC identifier may be mapped to the QoE Reference in the gNB. The application layer measurement report may be forwarded to OAM together with the QoE Reference. A network entity (e.g., the NG-RAN 708, a gNB, a base station) can release one or multiple application layer measurement configurations from the UE in one RRCReconfiguration 724 message at any time. The UE may additionally be configured by the network entity to report when a QoE measurement session starts or stops for a certain application layer measurement configuration.

As indicated, the UE App layer 812 may transmit the QoE Measurement Report to the UE AS 810 in a transparent report container. The UE AS 810 may transmit the transparent report container including the QoE measurement Report (i.e., QoE measurement results) to the NG-RAN 808 in an uplink RRC message. In greater detail, the UE App layer 812 may send an AT command 814 (with the QoE Measurement Report) to the UE AS 810 (e.g., the UE RRC layer). At 816, in response to receiving the AT command 814, the UE AS 810 may forward the measurement report for each application layer to the NG-RAN 810. The QoE Measurement report may be encapsulated in a QoE report container and may include the measConfigAppLayerID for each app layer. The QoE report container may be transparent to the UE AS 810. At 818, the NG-RAN 808 may transmit the QoE measurement report, in the QoE transparent report container, along with the corresponding QoE Reference ID to the OAM 804 and/or the TCE/MCE 802.

The QoE measurement collection is handled by application layer measurement configuration and measurement reporting and is presently supported in RRC_CONNECTED state only. However, described herein are features that facilitate the measurement reporting to continue in either or both of the RRC_INACTIVE and RRC_IDLE states.

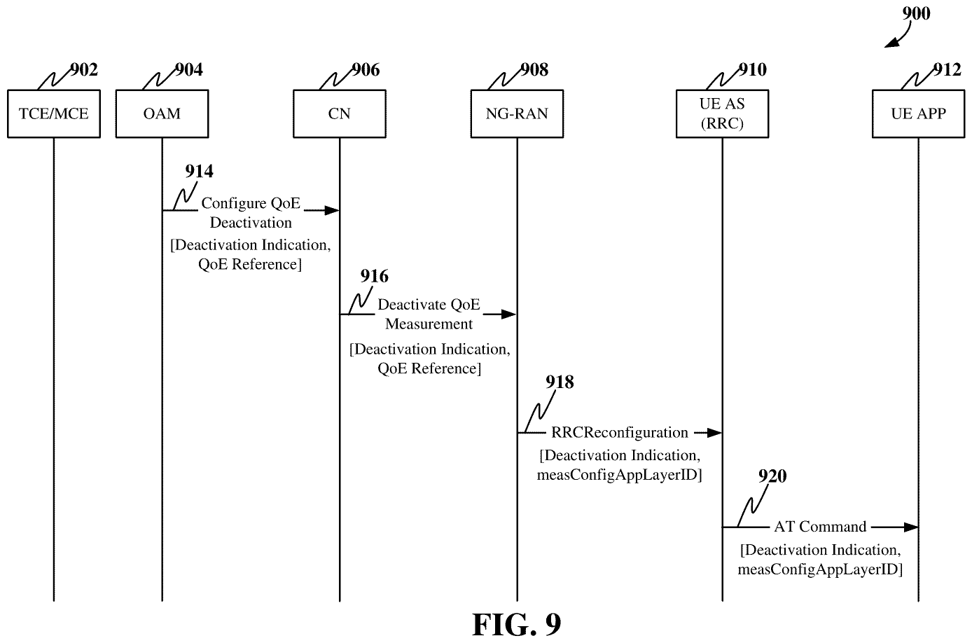

FIG. 9 is a call flow diagram 900 illustrating QoE Measurement Collection (QMC) deactivation or release according to some aspects of the disclosure. As in FIGS. 7 and 8, the call flow diagram 900 of FIG. 9 includes a TCE/MCE 902, an OAM 904, a CN 906, an NG-RAN 908, a UE AS 910 (e.g., a UE RRC layer), and a UE App layer 912.

The following conditions may result in the deactivation or release of QoE measurement collection job(s). In one example, the OAM 904 may transmit a Configure QE Deactivation 914 message, which may trigger the deactivation of a list of QoE measurement collection job(s). In some examples, the deactivation of QoE measurement collection may be achieved by providing a list of QoE Reference values. In another example, the NG-RAN 908 may release one or multiple application layer measurement configurations from the UE in one RRCReconfiguration 918 message at any time. According to some aspects, if the UE enters the RRC_IDLE state, the UE may release all of the QoE Measurement Configuration(s). In one example, upon reception of a release command at a UE, if one QoE Measurement Configuration is released, the UE AS 910 (e.g., the UE RRC layer) may inform the upper layer (e.g., the UE App layer 912) to release the QoE Measurement Configuration.

In greater detail, the OAM 904 may transmit a Configure QoE Deactivation 914 message to the CN 906. The Configure QoE Deactivation 914 message may include a deactivation indication and a QoE reference. The CN 906 may, in turn, transmit a Deactivate QoE Measurement 916 message to the NG-RAN 908. The Deactivate QoE Measurement 916 message may include the deactivation indication and the QoE reference. The NG-RAN 908 may, in turn, transmit an RRCReconfiguration 918 message to the UE AS 910 (e.g., the UE RRC layer). The RRCReconfiguration 918 message may include the deactivation indication and a measConfigAppLayerID. The network can replace a configuration with another one by deactivating an existing measurement and configuring another measurement of the same configuration type.

For a broadcast communication service, the same service and the same specific content data are provided simultaneously to all UEs in a geographical area (i.e., all UEs in the broadcast service area that are authorized to receive the data). A broadcast communication service is delivered to the UEs using a broadcast session. A UE can receive a broadcast communication service in the RRC_IDLE, RRC_INACTIVE, and RRC_CONNECTED states. The UE can receive an MBS configuration (e.g., parameters needed for multicast traffic channel (MTCH) reception) for a broadcast session via a multicast configuration channel (MCCH) in the RRC_IDLE, RRC_INACTIVE, and RRC_CONNECTED states. The parameters needed for the reception of MCCH may be provided via System Information.

In one aspect, a first QoE configuration may be activated at a UE. In one example, the UE may transition from an RRC_CONNECTED to an RRC_IDLE or an RRC_INACTIVE state. Currently, when the UE in the RRC_IDLE or RRC_INACTIVE state collects QoE data for a broadcast service, the UE buffers the collected QoE data. However, the UE will not trigger an RRC connection procedure or an RRC resume procedure for QoE reporting purposes. Consequently, the UE only sends QoE data after the UE enters the RRC_CONNECTED state due to other reasons (i.e., reasons unrelated to QoE reporting). However, when the QoE configuration is deactivated, currently, the UE deletes the buffered QoE data, so the buffered QoE data is lost.

According to aspects herein, features to avoid the data loss of the buffered data collected in the RRC_IDLE and/or RRC_INNACTIVE states in response to receiving a command to deactivate a current QoE configuration are described. According to one aspect, the UE initiates an RRC connection setup procedure or an RRC connection resume procedure when a given QoE configuration is deactivated. Accordingly, when the UE determines to deactivate the QoE configuration, the UE initiates the RRC connection setup procedure or the RRC connection resume procedure and enters the RRC_CONNECTED state in order to report the QoE data that was buffered while the UE was in the RRC_IDLE and/or RRC_INACTIVE states.

According to another aspect, when a UE determines to deactivate a QoE configuration, the UE buffers the QoE data (i.e., saves the buffered QoE data) but stops QoE measurement. Additionally, the UE may keep (e.g., store, maintain in memory) the deactivated QoE configuration.

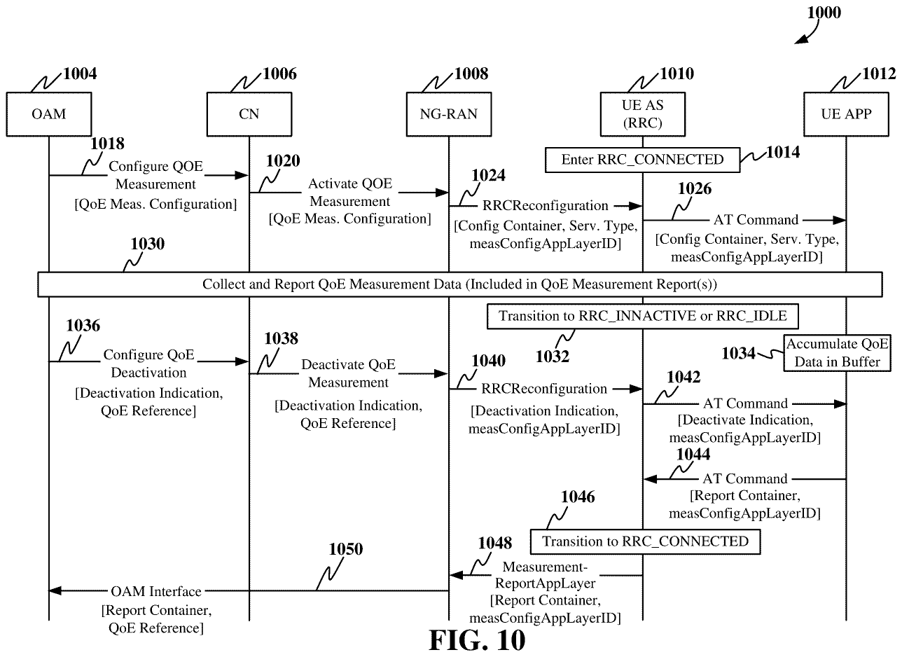

FIG. 10 is a call flow diagram 1000 illustrating the accumulation of quality of experience (QoE) data in a buffer during an RRC_INACTIVE and/or an RRC_IDLE state and a reporting of the buffered QoE data in response to receiving a QoE Measurement Collection (QMC) deactivation indication according to some aspects of the disclosure. As in FIGS. 7, 8, and 9, the call flow diagram 1000 of FIG. 10 includes an OAM 1004, a CN 1006, an NG-RAN 1008, a UE AS 1010 (e.g., a UE RRC layer), and a UE App layer 1012. A TCE/MCE is not illustrated to avoid cluttering the drawing.

In the example of FIG. 10, the UE has entered an RRC_CONNECTED state 1014 before being configured with QoE Measurement Configuration information. However, this is only an example presented for ease of illustration. The UE could enter the RRC_CONNECTED state before or after being configured with the QoE Measurement Configuration information.

FIG. 10 depicts Signaling-based QoE Measurement Collection Activation (e.g., similar to the Signaling-based 716 QoE Measurement Collection Activation as shown and described in connection with FIG. 7). However, the depiction of Signaling-based QoE Measurement Collection Activation is not intended to be limiting. Either Signaling-based QoE Measurement Collection Activation or Management-based QoE Measurement Collection Activation (e.g., similar to the Management-based 722 QoE Measurement Collection Activation as shown and described in connection with FIG. 7) could be used to configure and activate QoE measurement collection (QMC) at the UE.

In the example of FIG. 10, the OAM 1004 may send a Configure QoE Measurement Collection 718 message to the CN 1006. The Configure QoE Measurement Collection 1018 message may carry QoE Measurement Configuration information.

In response to receiving the Configure QoE Measurement Collection 1018 message, the CN 1006 may send an Activate QoE Measurement Collection 1020 message carrying the QoE Measurement Configuration data to the NG-RAN 708. Application layer QoE Measurement Configuration information received by the NG-RAN 1008 from the OAM 1004 (e.g., in Signaling-based QoE Measurement Collection Activation) or the CN 1006 (e.g., in Measurement-based QoE Measurement Collection Activation, not shown) may be encapsulated in a transparent container, which may be forwarded to a UE as Application layer QoE Measurement Configuration data in an RRCReconfiguration 1024 message (there can be multiple configurations in the same message).

In response to receiving the RRCReconfiguration 1024 message, the UE AS 710 (e.g., the UE RRC layer) may send an AT command 1026 to the UE App layer 1012. The AT command 726 may include the QoE Measurement Configuration Container, service type, and measConfigAppLayerID, for example.

Thereafter, while in the RRC_CONNECTED state and as shown in a general manner at 1030, the UE could collect and report QoE measurement data (included in QoE measurement report(s)) according to the aspects of the call flow diagram 800 as shown and described in connection with FIG. 8, for example.

Subsequently, at 1032, the UE may have transitioned from the RRC_CONNECTED state to either an RRC_INACTIVE state (e.g., with an RRC release with suspend command) or to an RRC_IDLE state (with an RRC release command), both transitions as shown and described in connection with FIG. 6. While in the RRC_INACTIVE state or the RRC_IDLE state, the UE (e.g., at the UE App layer 1012) could accumulate QoE data in a buffer.

During, or at some point relative to the ongoing measurement and accumulation of QoE data in the buffer 1034, the OAM 1004 may transmit a Configure QoE Deactivation 1036 message to the CN 1006. The Configure QoE Deactivation 1036 message may carry a deactivation indication and a QoE reference as shown and described in connection with FIG. 9.

In response to receiving the Configure QoE Deactivation 1036 message, the CN 1006 may send a Deactivate QoE Measurement 1038 message to the NG-RAN 1008. The Deactivate QoE Measurement 1038 message may carry the deactivation indication and the QoE reference as shown and described in connection with FIG. 9.

In response to receiving the Deactivate QoE Measurement 1038 message, the NG-RAN 1008 may send an RRCReconfiguration 1040 message including the deactivation indication and measConfigAppLayerID to the UE AS 1010 (e.g., the UE RRC layer). The UE AS 1010 may send the deactivation indication and the measConfigAppLayerID to the UE App layer 1012 in a first AT command 1042.

In response to receiving the first AT command 1042, the UE App layer 1012 may collect the QoE data from the buffer and package the data in a report. The UE App layer 1012 layer may include the report in a transparent report container. The UE App layer 1012 may send the transparent report container (including the accumulated QoE data from the buffer in the report) and the measConfigAppLayerID in a second AT command 1044 to the UE AS 1010.

In response to receiving the second AT command 1044, or in response to receiving the RRCReconfiguration 1040 message, the UE AS 1010 may transition to a new RRC_CONNECTED state. Thereafter, the UE AS 1010 may send a MeasurementReportAppLayer 1048 message including the transparent report container and the measConfigAppLayerID to the NG-RAN 1008.

In the example of FIG. 10, in response to receiving the MeasurementReportAppLayer 1048 message, the NG-RAN 1008 sends an OAM Interface 1050 message including the transparent report container and the QoE reference to the OAM 1004. The transparent report container and the QoE reference could be sent to a TCE/MCE (not shown) either from the OAM 1004 or from the NG-RAN 1008 according to some aspects.

Accordingly, aspects described herein may avoid the loss of buffered QoE data collected by the UE while in an RRC_INACTIVE state or an RRC_IDLE state, by reporting such data instead of erasing such data when a QE configuration is deactivated while the UE is in the RRC_INACTIVE state or an RRC_IDLE state.

In some examples, when the UE determines to deactivate the QoE configuration, the UE may initiate an RRC connection setup procedure or an RRC connection resume procedure if there is QoE data buffered. In some examples the UE initiates the RRC connection setup procedure or the RRC connection resume procedure if there is QoE buffered when the QoE configuration is deactivated.

According to some aspects, there could be criterion configured to or preconfigured in the UE to assist the UE with determining whether to initiate the RRC connection setup procedure or the RRC connection resume procedure. By way of example and without limitation, the criterion could be one or combination of: a volume threshold (e.g., if the buffered QoE data is above (or below) the volume threshold, then the UE initiates the RRC connection setup procedure or the RRC connection resume procedure), a time threshold (or time duration) against which the time that the QoE data is buffered or measured may be established (e.g., if the QoE data is measured or buffered for a time duration shorter than (or longer than) the time threshold, the UE initiates the RRC connection setup procedure or the RRC connection resume procedure), or configured QoE information (e.g., where QoE information could be, without limitation, a service type, a slice, a QoE reference, an MBS session, a QoE configuration RRC ID). By way of example, if the QoE information of buffered data corresponds to one or more of the configured QoE information, the UE may initiate the RRC connection setup procedure or the RRC connection resume procedure.

According to some aspects, the criterion may be configured to the AS layer (e.g., the RRC layer of the UE), and the AS layer may determine whether to initiate the RRC connection setup procedure or the RRC connection resume procedure, or the criterion may be configured to the application layer (e.g., the application layer of the UE) and the application layer may determine whether to deliver the buffered data to the AS layer. According to some aspects, the network may provide the criterion via an RRC message (e.g., an RRCReconfiguration or an RRCRelease message).

According to some examples, an RRC connection resume procedure may also include a procedure used by the UE to initiate a small data transition (SDT) in the RRC_INACTIVE state. In addition, according to some aspects, when the QoE configuration is deactivated at the network, the UE may release the QoE configuration at the UE.

According to some aspects, when the UE determines to deactivate the QoE configuration, the UE may buffer the QoE data but stop (or suspend) QoE measurement. According to some examples, when the UE determines to deactivate the QoE configuration the UE may continue to buffer the collected QoE data and the UE AS layer may indicate to the UE application layer to suspend (temporarily stop) QoE measurement. In some examples, the UE application layer may continue with ongoing QoE measurement sessions but may not start new QoE measurements sessions. In some examples, the UE may keep (e.g., store, retain in memory) a current or present QoE configuration when that QoE configuration is deactivated. In some examples the UE may be configured by the network or preconfigured by an OEM with a timer. The timer may be used to determine when to discard the deactivated QoE configuration and the corresponding QoE data associated with that deactivated configuration. For example, and without limitation, if the timer expires, the UE may delete the QoE configuration and the corresponding QoE data or the UE may initiate the RRC connection setup procedure or the RRC connection resume procedure as described above.

In some examples, a UE may consider the QoE configuration to be deactivated under one or more of the following conditions: a QoE configuration validity timer expires, or the UE moves outside of a QoE area scope.

In some examples, a UE may re-activate a deactivated QoE configuration under one or more of the following conditions: the UE re-enters the QoE area scope, or the UE receives a command from the network to re-activate a deactivated QoE configuration upon entering an RRC_CONNECTED state.

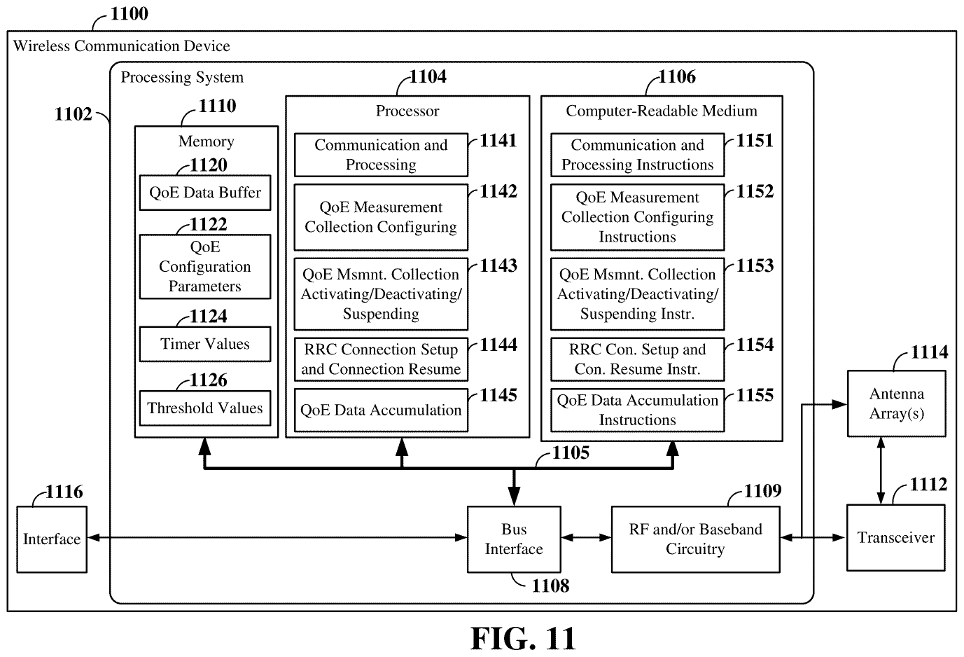

FIG. 11 is a block diagram illustrating an example of a hardware implementation of a wireless communication device 1100 (e.g., user equipment, a scheduled entity) employing a processing system 1102 according to some aspects. The wireless communication device 1100 may be similar to, for example, any of the wireless communication devices, UEs, or scheduled entities of FIGS. 1, 2, 3, 5, 7, 8, 9, and/or 10.

In accordance with various aspects of the disclosure, an element, or any portion of an element, or any combination of elements may be implemented with a processing system 1102 that includes one or more processors, such as processor 1104. Examples of processors 1104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the wireless communication device 1100 may be configured to perform any one or more of the functions described herein. That is, the processor 1104, as utilized in the wireless communication device 1100, may be used to implement any one or more of the methods or processes described and illustrated, for example, in FIGS. 6, 7, 8, 9, and/or 10.

In this example, the processing system 1102 may be implemented with a bus architecture, represented generally by the bus 1105. The bus 1105 may include any number of interconnecting buses and bridges depending on the specific application of the processing system 1102 and the overall design constraints. The bus 1105 communicatively couples together various circuits including one or more processors (represented generally by the processor 1104), a memory 1110, and computer-readable media (represented generally by the computer-readable medium 1106). The bus 1105 may also link various other circuits such as timing sources, peripherals, voltage regulators, and power management circuits, which are well known in the art, and therefore, will not be described any further.

A bus interface 1108 provides an interface between the bus 1105, a transceiver 1112, and one or more antenna arrays 1114. The transceiver 1112 may be, for example, a wireless transceiver. The transceiver 1112 provides a means for communicating with various other apparatus over a transmission medium (e.g., air interface). The transceiver 1112 may be coupled to the one or more antenna arrays 1114. The bus interface 1108 further provides an interface between the bus 1105 and a user interface 1116 (e.g., keypad, display, touch screen, speaker, microphone, control features, etc.). Of course, such a user interface 1116 is optional, and may be omitted in some examples.

One or more processors, such as processor 1104, may be responsible for managing the bus 1105 and general processing, including the execution of software stored on the computer-readable medium 1106. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 1106. The software, when executed by the processor 1104, causes the processing system 1102 to perform the various processes and functions described herein for any particular apparatus.

The computer-readable medium 1106 may be a non-transitory computer-readable medium and may be referred to as a computer-readable storage medium or a non-transitory computer-readable medium. The non-transitory computer-readable medium may store computer-executable code (e.g., processor-executable code). The computer executable code may include code for causing a computer (e.g., a processor) to implement one or more of the functions described herein. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1106 may reside in the processing system 1102, external to the processing system 1102, or distributed across multiple entities including the processing system 1102. The computer-readable medium 1106 may be embodied in a computer program product or article of manufacture. By way of example, a computer program product or article of manufacture may include a computer-readable medium in packaging materials. In some examples, the computer-readable medium 1106 may be part of the memory 1110. Those skilled in the art will recognize how best to implement the described functionality presented throughout this disclosure depending on the particular application and the overall design constraints imposed on the overall system. The computer-readable medium 1106 and/or the memory 1110 may also be used for storing data that is manipulated by the processor 1104 when executing software. For example, the memory 1110 may include a QoE data buffer 1120 that may accumulate QoE data while the wireless communication device 1100 is in an RRC_INACTIVE state or an RRC_IDLE state. By way of another example, the memory 1110 may store QoE configuration parameters 1122 that may be used to configure the wireless communication device 1100 in connection with QoE measurement collection. Still further, the memory 1110 may store timer values 1124 and/or threshold values 1126 as described herein.

In some aspects of the disclosure, the processor 1104 may include communication and processing circuitry 1141 configured for various functions, including for example communicating with a network entity (e.g., a gNB, a base station, a scheduled entity), a network core (e.g., a 5G core network), and another wireless communication device (e.g., a UE, a scheduled entity), or any other entity, such as, for example, local infrastructure or an entity communicating with the wireless communication device 1100 via the Internet, such as a network provider. In some examples, the communication and processing circuitry 1141 may include one or more hardware components that provide the physical structure that performs processes related to wireless communication (e.g., signal reception and/or signal transmission) and signal processing (e.g., processing a received signal and/or processing a signal for transmission). The communication and processing circuitry 1141 may further be configured to execute communication and processing instructions 1151 (e.g., software) stored on the computer-readable medium 1106 to implement one or more functions described herein.

In some aspects of the disclosure, the processor 1104 may include QoE Measurement Collection Configuring circuitry 1142 configured for various functions, including, for example, receiving an AT command (e.g., similar to the AT Command 1026 as shown and described in connection with FIG. 10) and configuring a protocol layer of the wireless communication device (e.g., the UE App layer 1012 as shown and described in connection with FIG. 10) according to an Application Layer QoE Measurement Configuration. The QoE Measurement Collection Configuring circuitry 1142 may also be configured to unpack a container (e.g., the config container as shown and described in connection with the AT Command 1026 of FIG. 10). According to some aspects, the QoE Measurement Collection Configuring circuitry 1142 may be configured to stop accumulating QoE data in a buffer (e.g., in the QoE data buffer 1120 of the memory 1110) in response to determining to Deactivate QoE Configuration message, and store parameters associated with a QoE configuration (such as, for example the Application Layer QoE Measurement Configuration received with the AT command). In one example, the QoE configuration may be stored in a QoE configuration parameters 1122 portion of the memory 1110. The QoE Measurement Collection Configuring circuitry 1142 may further be configured to execute QoE Measurement Collection Configuring instructions 1152 (e.g., software) stored on the computer-readable medium 1106 to implement one or more functions described herein.

In some aspects of the disclosure, the processor 1104 may include QoE Measurement Collection Activating/Deactivating/Suspending circuitry 1143 configured for various functions, including, for example, activating a quality of experience (QoE) configuration (e.g., the Application Layer QoE Measurement Configuration described in connection with the QoE measurement collection configuring circuitry 1142 above). The QoE configuration may be activated at an application layer of the wireless communication device 1100, for example. The QoE Measurement Collection Activating/Deactivating/Suspending circuitry 1143 may also be configured for additional functions, such as, for example, re-activating the QoE configuration in accordance with the stored parameters of the QoE configuration in response to expiration of a timer. In another example, the re-activating the QoE configuration may be in response to determining, at the wireless communication device 1100, that the wireless communication device 1100 has moved inside of a predetermined QoE area scope after having been outside of the predetermined QoE area scope, or receiving an indication, from a network entity, to re-activate the QoE configuration upon entering a new RRC_CONNECTED state. The stored parameters of the QoE configuration may be stored, for example, in the QoE configuration parameters 1122 portion of the memory 1110. The timer may be implemented, for example, using the communication and processing circuitry 1141. The timer value may be stored, for example, in the timer values 1124 portion of the memory 1110. In some examples, the timer, or another timer, may be started in response to deactivating the QoE configuration.

The QoE Measurement Collection Activating/Deactivating/Suspending circuitry 1143 may also be configured for additional functions, such as, for example, deactivating the QoE configuration and/or performing an additional deactivation of the QoE configuration after an earlier re-activation of the QoE configuration. According to some aspects, the QoE Measurement Collection Activating/Deactivating/Suspending circuitry 1143 may be configured such that, in response to receiving an indication to deactivate the QoE configuration from a network entity, the wireless communication device 1100 releases the QoE configuration. According to some aspects, deactivating the QoE configuration may occur in response to at least one of: the expiration of a QoE configuration validity timer at the wireless communication device 1100, or a determination, made at the wireless communication device 1100, that the wireless communication device 1100 has moved outside of a predetermined QoE area scope. According to one aspect, the QoE Measurement Collection Activating/Deactivating/Suspending circuitry 1143 may be configured to start a timer in response to the deactivating the QoE configuration (i.e., in response to receiving a deactivate QoE configuration message), and delete the QoE configuration (e.g., stored in the QoE configuration parameters 1122 portion of the memory 1110) and corresponding QoE data in the buffer (e.g., in the QoE data buffer 1120 of the memory 1110) in response to expiration of the timer.

The QoE Measurement Collection Activating/Deactivating/Suspending circuitry 1143 may also be configured for additional functions, such as, for example, conveying an indication, from an RRC layer to an application layer of the wireless communication device 1100, to suspend QoE measurements. The QoE Measurement Collection Activating/Deactivating/Suspending circuitry 1143 may further be configured to execute QoE measurement collection activating/deactivating/suspending instructions 1153 (e.g., software) stored on the computer-readable medium 1106 to implement one or more functions described herein.

In some aspects of the disclosure, the processor 1104 may include RRC Connection Setup Procedure and RRC Connection Resume Procedure circuitry 1144 configured for various functions, including, for example, determining to transition among the RRC_CONNECTED, RRC_INACTIVE, and RRC_IDLE states of the wireless communication device 1100. According to some aspects, the RRC Connection Setup Procedure and RRC Connection Resume Procedure circuitry 1144 may be configured for other functions, such as, for example, initiating an RRC connection setup procedure from the RRC_IDLE state or an RRC connection resume procedure, from an RRC_INACTIVE state, in response to both having the QoE data in the buffer (e.g., the QoE data buffer 1120 of the memory 1110) and the deactivating the QoE configuration (i.e., obtaining a QoE deactivation message). In some aspects, the RRC Connection Setup Procedure and RRC Connection Resume Procedure circuitry 1144 may further be configured to initiate a new RRC connection setup procedure from a new RRC_IDLE state, or a new RRC connection resume procedure from a new RRC_INACTIVE state, in response to both having the QoE data in the buffer (e.g., the QoE data buffer 1120 of the memory 1110) and the additional deactivation of the QoE configuration (i.e., obtaining an additional QoE deactivation message).

According to some aspects of the disclosure, the RRC Connection Setup Procedure and RRC Connection Resume Procedure circuitry 1144 may further be configured to, for example, obtain criterion utilized to determine whether to initiate the RRC connection setup procedure or the RRC connection resume procedure. In some examples, the criterion may be configured to the wireless communication device or may be preconfigured in the wireless communication device. In some examples, the criterion may include at least one of a first threshold against which an amount of the QoE data in the buffer is compared, a second threshold against which an elapsed time since a start of QoE data measurement or a start of the accumulating of the QoE data in the buffer is compared, or receipt of QoE data associated with QoE information in a predetermined set of QoE information. In some examples, satisfying any one or more of the criterion may cause the wireless communication device to initiate the RRC connection setup procedure or the RRC connection resume procedure.

One example of the buffer may be the QoE data buffer 1120 in memory 1110. In some examples, the elapsed time may be measured by the communication and processing circuitry 1141, while the first threshold against which the amount of the QoE data in the buffer is compared, and the second threshold against which the elapsed time since the start of QoE data measurement or the start of the accumulating of the QoE data in the buffer is compared may be stored in the threshold values 1126 portion of the memory 1110. In some examples, the predetermined set of QoE information may include at least one of a service type, slice scope, QoE reference, multicast and broadcast service (MBS) sessions, or QoE configuration RRC identifier. In some examples, the criterion may be configured to an RRC layer of the wireless communication device, 1100 and the wireless communication device may be configured to obtain, by the RRC layer, the criterion, and utilize, by the RRC layer, the criterion to determine whether to initiate the RRC connection setup procedure or the RRC connection resume procedure.

According to some aspects, the criterion may be configured to an application layer of the wireless communication device 1100. The wireless communication device 1100 may be configured to obtain, by the application layer, the criterion, and utilize, by the application layer, the criterion to determine whether to deliver the QoE data in the buffer to an RRC layer of the wireless communication device 1100. According to some aspects, the wireless communication device 1100 may obtain the criterion via an RRC message received from a network entity. In some examples, the RRC connection resume procedure includes initiation of a small data transmission (SDT) during the RRC_INACTIVE state, and the SDT may be utilized to send the QoE data in the buffer (e.g., the QoE data buffer 1120 of the memory 1110) to the network entity. The RRC Connection Setup Procedure and RRC Connection Resume Procedure circuitry 1144 may further be configured to execute RRC connection setup procedure and RRC connection resume procedure instructions 1154 (e.g., software) stored on the computer-readable medium 1106 to implement one or more functions described herein.

In some aspects of the disclosure, the processor 1104 may include QoE data accumulation circuitry 1145 configured for various functions, including, for example, accumulating QoE data in a buffer (e.g., the QoE data buffer 1120 of the memory 1110) while in a radio resource control (RRC) inactive state or an RRC_IDLE state subsequent to activating the QoE configuration, and accumulating new QoE data in the buffer while in a new RRC_INACTIVE state or a new RRC_IDLE state subsequent to a re-activating of a QoE configuration. The QoE data accumulation circuitry 1145 may further be configured to send the QoE data in the buffer to a network entity following entry into an RRC_CONNECTED state at a conclusion of an RRC connection setup procedure or an RRC connection resume procedure and be further configured to send new QoE data in the buffer to the network entity following entry into a new RRC_CONNECTED state at a conclusion of a new RRC connection setup procedure or a new RRC connection resume procedure. The QoE data accumulation circuitry 1145 may further be configured to execute QoE data accumulation instructions 1155 (e.g., software) stored on the computer-readable medium 1106 to implement one or more functions described herein.

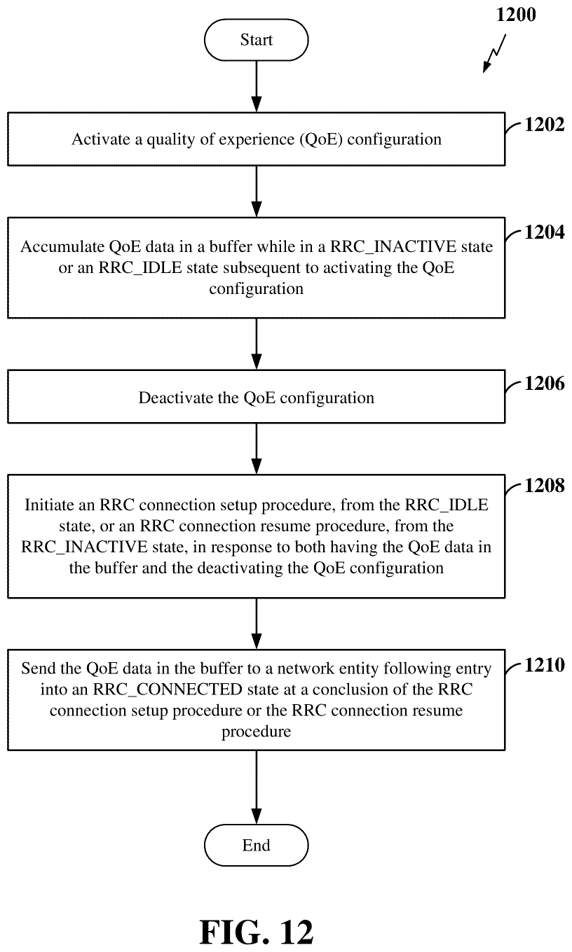

FIG. 12 is a flow chart illustrating an example process 1200 (e.g., a method) of wireless communication at a wireless communication device in accordance with some aspects of the disclosure. As described below, some or all illustrated features may be omitted in a particular implementation within the scope of the present disclosure, and some illustrated features may not be required for implementation of all embodiments. In some examples, the process 1200 may be carried out by the wireless communication device 1100 as illustrated and described in connection with FIG. 11. The wireless communication device 1100 may be similar to, for example, any of the wireless communication devices, UEs, or scheduled entities of FIGS. 1, 2, 3, 5, 6, 7, 8, 9, and/or 10. In some examples, the process 1200 may be carried out by any suitable apparatus or means for carrying out the functions or algorithm described below.

At block 1202, the wireless communication device may activate a quality of experience (QoE) configuration. For example, the QoE Measurement Collection Activating/Deactivating/Suspending circuitry 1143 shown and described above in connection with FIG. 11 may provide a means for activating a quality of experience (QoE) configuration.

At block 1204, the wireless communication device may accumulate QoE data in a buffer while in a radio resource control inactive (RRC_INACTIVE) state or an RRC_IDLE state subsequent to activating the QoE configuration. For example, the QoE data accumulation circuitry 1145 shown and described in connection with FIG. 11 may provide a means for accumulating QoE data in a buffer while in an RRC_INACTIVE state or an RRC_IDLE state subsequent to activating the QoE configuration.

At block 1206, the wireless communication device may deactivate the QoE configuration. For example, QoE Measurement Collection Activating/Deactivating/Suspending circuitry 1143 as shown and described in connection with FIG. 11 may provide a means for deactivating the QoE configuration. In some examples, deactivating the QoE configuration occurs in response to at least one of: expiration of a QoE configuration validity timer at the wireless communication device, or a determination, made at the wireless communication device, that the wireless communication device has moved outside of a predetermined QoE area scope.

At block 1208, the wireless communication device may initiate an RRC connection setup procedure, from the RRC_IDLE state, or an RRC connection resume procedure, from the RRC_INACTIVE state, in response to both having the QoE data in the buffer and the deactivating the QoE configuration. For example, the RRC Connection Setup Procedure and RRC Connection Resume Procedure circuitry 1144 as shown and described in connection with FIG. 11 may provide a means for initiating an RRC connection setup procedure, from the RRC_IDLE state, or an RRC connection resume procedure, from the RRC_INACTIVE state, in response to both having the QoE data in the buffer and the deactivating the QoE configuration.

According to some aspects, the wireless communication device may further be configured to obtain criterion utilized to determine whether to initiate the RRC connection setup procedure or the RRC connection resume procedure. For example, the RRC Connection Setup Procedure and RRC Connection Resume Procedure circuitry 1144 as shown and described in connection with FIG. 11 may provide a means for obtaining criterion utilized to determine whether to initiate the RRC connection setup procedure or the RRC connection resume procedure. According to some aspects, the criterion may be configured to the wireless communication device or may be preconfigured in the wireless communication device. In some examples, the criterion are at least one of: a first threshold against which an amount of the QoE data in the buffer is compared, a second threshold against which an elapsed time since a start of QoE data measurement or a start of the accumulating of the QoE data in the buffer is compared, or receipt of QoE data associated with QoE information in a predetermined set of QoE information, and satisfying any one or more of the criterion causes the wireless communication device to initiate the RRC connection setup procedure or the RRC connection resume procedure. In some examples, the predetermined set of QoE information may include at least one of: a service type, slice scope, QoE reference, multicast and broadcast service (MBS) sessions, or QoE configuration RRC identifier.

In some examples, the criterion is configured to an RRC layer of the wireless communication device, and the wireless communication device may further: obtain, by the RRC layer, the criterion, and utilizing, by the RRC layer, the criterion to determine whether to initiate the RRC connection setup procedure or the RRC connection resume procedure. For example, the RRC Connection Setup Procedure and RRC Connection Resume Procedure circuitry 1144 as shown and described in connection with FIG. 11 may provide a means for obtaining, by the RRC layer, the criterion, and utilizing, by the RRC layer, the criterion to determine whether to initiate the RRC connection setup procedure or the RRC connection resume procedure.

In some examples, the criterion is configured to an application layer of the wireless communication device, and the wireless communication device is further configured to obtain, by the application layer, the criterion, and utilize, by the application layer, the criterion to determine whether to deliver the QoE data in the buffer to an RRC layer of the wireless communication device. For example, the RRC Connection Setup Procedure and RRC Connection Resume Procedure circuitry 1144 as shown and described in connection with FIG. 11 may provide a means for obtaining, by the application layer, the criterion, and a means for utilizing, by the application layer, the criterion to determine whether to deliver the QoE data in the buffer to an RRC layer of the wireless communication device.

In some aspects, the wireless communication device obtains the criterion via an RRC message received from the network entity. In some aspects, the RRC connection resume procedure includes an initiation of a small data transmission (SDT) during the RRC_INACTIVE state, the SDT being utilized to send the QoE data in the buffer to the network entity. In some aspects, in response to receiving an indication to deactivate the QoE configuration from the network entity, the wireless communication device releases the QoE configuration. For example, the RRC Connection Setup Procedure and RRC Connection Resume Procedure circuitry 1144 may provide a means for releasing the QoE configuration in response to receiving an indication to deactivate the QoE configuration from the network entity.

At block 1210, the wireless communication device may send the QoE data in the buffer to a network entity following entry into an RRC_CONNECTED state at a conclusion of the RRC connection setup procedure or the RRC connection resume procedure. For example, the QoE data accumulation circuitry 1145 as shown and described in connection with FIG. 11 may provide a means for sending the QoE data in the buffer to a network entity following entry into an RRC_CONNECTED state at a conclusion of the RRC connection setup procedure or the RRC connection resume procedure.

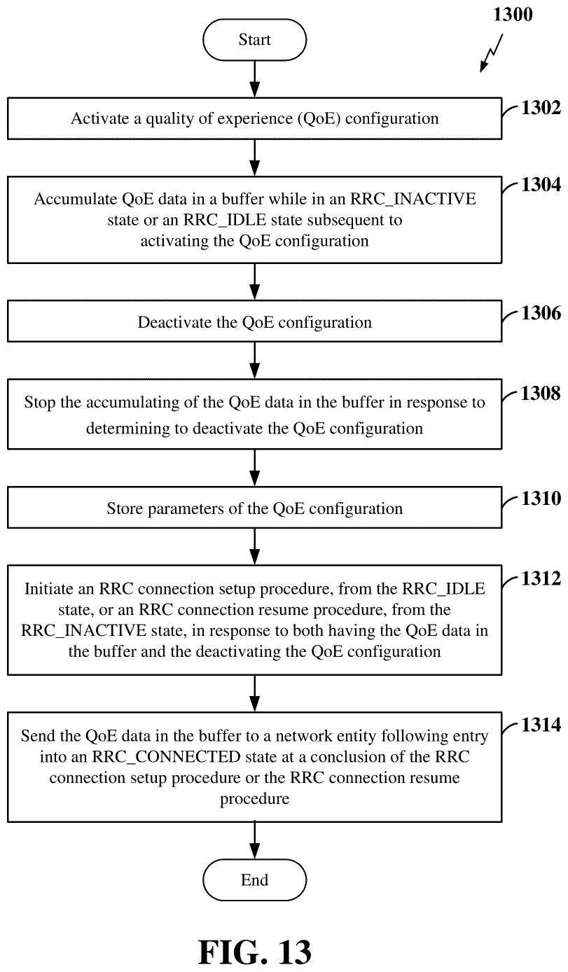

FIG. 13 is a flow chart illustrating an example process 1300 (e.g., a method) of wireless communication at a wireless communication device in accordance with some aspects of the disclosure. As described below, some or all illustrated features may be omitted in a particular implementation within the scope of the present disclosure, and some illustrated features may not be required for implementation of all embodiments. In some examples, the process 1300 may be carried out by the wireless communication device 1100 as illustrated and described in connection with FIG. 11. The wireless communication device 1100 may be similar to, for example, any of the wireless communication devices, UEs, or scheduled entities of FIGS. 1, 2, 3, 5, 6, 7, 8, 9, and/or 10. In some examples, the process 1300 may be carried out by any suitable apparatus or means for carrying out the functions or algorithm described below.

At block 1302, the wireless communication device may activate a quality of experience (QoE) configuration. For example, the QoE Measurement Collection Activating/Deactivating/Suspending circuitry 1143 shown and described above in connection with FIG. 11 may provide a means for activating a quality of experience (QoE) configuration.

At block 1304, the wireless communication device may accumulate QoE data in a buffer while in a radio resource control inactive (RRC_INACTIVE) state or an RRC_IDLE state subsequent to activating the QoE configuration. For example, the QoE data accumulation circuitry 1145 shown and described in connection with FIG. 11 may provide a means for accumulating QoE data in a buffer while in a radio resource control (RRC) inactive state or an RRC_IDLE state subsequent to activating the QoE configuration. According to some aspects, At block 1306, the wireless communication device may deactivate the QoE configuration. For example, the QoE Measurement Collection Activating/Deactivating/Suspending circuitry 1143 as shown and described in connection with FIG. 11 may provide a means for deactivating the QoE configuration.

At block 1308, the wireless communication device may stop the accumulating of the QoE data in response to determining to deactivate the QoE configuration. For example, the QoE Measurement Collection Activating/Deactivating/Suspending circuitry 1143 as shown and described in connection with FIG. 11 may provide a means for stopping the accumulating of the QoE data in the buffer in response to determining to deactivate the QoE configuration.

At block 1310, the wireless communication device may store parameters of the QoE configuration. For example, the QoE measurement collection configuring circuitry 1142 in connection with the QoE configuration parameters 1122 portion of the memory 1110 as shown and described in connection with FIG. 11 may provide a means for storing parameters of the QoE configuration.

In some examples, the wireless communication device may convey an indication, from an RRC layer to an application layer of the wireless communication device, to suspend QoE measurements. For example, the QoE Measurement Collection Activating/Deactivating/Suspending circuitry 1143 as shown and described in connection with FIG. 11 may provide a means for conveying an indication, from an RRC layer to an application layer of the wireless communication device, to suspend QoE measurements.

In some examples, the wireless communication device may start a timer in response to the deactivating the QoE configuration and delete the QoE configuration and corresponding QoE data in the buffer in response to expiration of the timer. For example, the QoE Measurement Collection Activating/Deactivating/Suspending circuitry 1143 as shown and described in connection with FIG. 11 may provide a means for starting a timer in response to the deactivating the QoE configuration, and a means for deleting the QoE configuration and corresponding QoE data in the buffer in response to expiration of the timer.

In some examples, the wireless communication device may start a timer in response to the deactivating the QoE configuration, accumulate new QoE data in the buffer while in a new RRC_INACTIVE state or a new RRC_IDLE state, and, in response to an expiration of the timer: release the QoE configuration and QoE data in the buffer, or initiate a new RRC connection setup procedure, from the new RRC_IDLE state, or a new RRC connection resume procedure, from the new RRC_INACTIVE state, in response to both having the QoE data in the buffer and the additional deactivation of the QoE configuration, and send the new QoE data in the buffer to the network entity following entry into a new RRC_CONNECTED state at a conclusion of the new RRC connection setup procedure or the new RRC connection resume procedure. For example, the QoE Measurement Collection Activating/Deactivating/Suspending circuitry 1143 as shown and described in connection with FIG. 11 may provide a means for starting a timer in response to the deactivating the QoE configuration. The QoE data accumulation circuitry 1145 as shown and described in connection with FIG. 11 may provide a means for accumulating new QoE data in the buffer while in a new RRC_INACTIVE state or a new RRC_IDLE state subsequent to the re-activating the QoE configuration. The QoE Measurement Collection Activating/Deactivating/Suspending circuitry 1143 as shown and described in connection with FIG. 11 may provide a means for performing an additional deactivation of the QoE configuration. The RRC Connection Setup Procedure and RRC Connection Resume Procedure circuitry 1144 as shown and described in connection with FIG. 11 may provide a means for initiating a new RRC connection setup procedure, from the new RRC_IDLE state, or a new RRC connection resume procedure, from the new RRC_INACTIVE state, in response to both having the QoE data in the buffer and the additional deactivation of the QoE configuration, and provide a means for sending the new QoE data in the buffer to the network entity following entry into a new RRC_CONNECTED state at a conclusion of the new RRC connection setup procedure or the new RRC connection resume procedure.

In some examples, the wireless communication device may re-activate the QoE configuration in accordance with the stored parameters of the QoE configuration in response to: determining, at the wireless communication device, that the wireless communication device has moved inside of a predetermined QoE area scope after having been outside of the predetermined QoE area scope, or receiving an indication, from the network entity, to re-activate the QoE configuration upon entering a new RRC_CONNECTED state. For example, the QoE Measurement Collection Activating/Deactivating/Suspending circuitry 1143 may provide a means for re-activating the QoE configuration in accordance with the stored parameters of the QoE configuration in response to: determining, at the wireless communication device, that the wireless communication device has moved inside of a predetermined QoE area scope after having been outside of the predetermined QoE area scope, or receiving an indication, from the network entity, to re-activate the QoE configuration upon entering a new RRC_CONNECTED state.

At block 1312, the wireless communication device may initiate an RRC connection setup procedure, from the RRC_IDLE state, or an RRC connection resume procedure, from the RRC_INACTIVE state, in response to both having the QoE data in the buffer and the deactivating the QoE configuration. For example, the RRC Connection Setup Procedure and RRC Connection Resume Procedure circuitry 1144 as shown and described in connection with FIG. 11 may provide a means for initiating an RRC connection setup procedure, from the RRC_IDLE state, or an RRC connection resume procedure, from the RRC_INACTIVE state, in response to both having the QoE data in the buffer and the deactivating the QoE configuration.

At block 1314, the wireless communication device may send the QoE data in the buffer to a network entity following entry into an RRC_CONNECTED state at a conclusion of the RRC connection setup procedure or the RRC connection resume procedure. For example, the QoE data accumulation circuitry 1145 as shown and described in connection with FIG. 11 may provide a means for sending the QoE data in the buffer to a network entity following entry into an RRC_CONNECTED state at a conclusion of the RRC connection setup procedure or the RRC connection resume procedure.

Of course, in the above examples, the circuitry included in the processor 1104 of FIG. 11 is merely provided as an example. Other means for carrying out the described processes or functions may be included within various aspects of the present disclosure, including but not limited to the instructions stored in the computer-readable medium 1106 of FIG. 11 or any other suitable apparatus or means described in any one of the FIGS. 1, 2, 3, 5, 6, 7, 8, 9, 10, and/or 11 and utilizing, for example, the processes and/or algorithms described herein in relation to FIGS. 12 and/or 13.

The following provides an overview of aspects of the present disclosure:
Aspect 1: A wireless communication device, comprising: a memory, and a processor coupled to the memory, the processor being configured to: activate a quality of experience (QoE) configuration, accumulate QoE data in a buffer while in a radio resource control (RRC) inactive state or an RRC_IDLE state subsequent to activating the QoE configuration, deactivate the QoE configuration, initiate an RRC connection setup procedure, from the RRC_IDLE state, or an RRC connection resume procedure, from the RRC_INACTIVE state, in response to both having the QoE data in the buffer and the deactivate the QoE configuration, and send the QoE data in the buffer to a network entity following entry into an RRC_CONNECTED state at a conclusion of the RRC connection setup procedure or the RRC connection resume procedure.
Aspect 2: The wireless communication device of aspect 1, wherein the processor is further configured to: stop the accumulating of the QoE data in response to determining to deactivate the QoE configuration, and store parameters of the QoE configuration.
Aspect 3: The wireless communication device of aspect 1 or 2, wherein the processor is further configured to: convey an indication, from an RRC layer to an application layer of the wireless communication device, to suspend QoE measurements.
Aspect 4: The wireless communication device of any of aspects 1 through 3, wherein the processor is further configured to: start a timer in response to the deactivating the QoE configuration, and delete the QoE configuration and corresponding QoE data in the buffer in response to expiration of the timer.
Aspect 5: The wireless communication device of any of aspects 1 through 3, wherein the processor is further configured to: start a timer in response to the deactivating the QoE configuration, accumulate new QoE data in the buffer while in a new RRC_INACTIVE state or a new RRC_IDLE state, and, in response to an expiration of the timer: release the QoE configuration and QoE data in the buffer, or initiate a new RRC connection setup procedure, from the new RRC_IDLE state, or a new RRC connection resume procedure, from the new RRC_INACTIVE state, in response to both having the new QoE data in the buffer and the additional deactivation of the QoE configuration, and send the new QoE data in the buffer to the network entity following entry into a new RRC_CONNECTED state at a conclusion of the new RRC connection setup procedure or the new RRC connection resume procedure.
Aspect 6: The wireless communication device of any of aspects 1 through 5, wherein the processor is further configured to: re-activate the QoE configuration in accordance with the stored parameters of the QoE configuration in response to the processor being configured to: determine, at the wireless communication device, that the wireless communication device has moved inside of a predetermined QoE area scope after having been outside of the predetermined QoE area scope, or receive an indication, from the network entity, to re-activate the QoE configuration upon entering a new RRC_CONNECTED state.
Aspect 7: The wireless communication device of any of aspects 1 through 6, wherein the processor is further configured to: obtain criterion utilized to determine whether to initiate the RRC connection setup procedure or the RRC connection resume procedure.
Aspect 8: The wireless communication device of aspect 7, wherein the criterion are configured to the wireless communication device or are preconfigured in the wireless communication device.
Aspect 9: The wireless communication device of any of aspects 1 through 8, wherein the criterion includes at least one of: a first threshold against which an amount of the QoE data in the buffer is compared, a second threshold against which an elapsed time since a start of QoE data measurement or a start of the accumulating of the QoE data in the buffer is compared, or receipt of QoE data associated with QoE information in a predetermined set of QoE information, and satisfying any one or more of the criterion further configures the processor to initiate the RRC connection setup procedure or the RRC connection resume procedure.
Aspect 10: The wireless communication device of aspect 9, wherein the predetermined set of QoE information includes at least one of: a service type, slice scope, QoE reference, multicast and broadcast service (MBS) sessions, or QoE configuration RRC identifier.
Aspect 11: The wireless communication device of any of aspects 1 through 10, wherein the criterion is configured to an RRC layer of the wireless communication device, and the processor is further configured to: obtain, by the RRC layer, the criterion, and utilize, by the RRC layer, the criterion to determine whether to initiate the RRC connection setup procedure or the RRC connection resume procedure.
Aspect 12: The wireless communication device of any of aspects 1 through 11, wherein the criterion is configured to an application layer of the wireless communication device, and the processor is further configured to: obtain, by the application layer, the criterion, and utilize, by the application layer, the criterion to determine whether to deliver the QoE data in the buffer to an RRC layer of the wireless communication device.
Aspect 13: The wireless communication device of any of aspects 1 through 12, wherein the processor is configured to obtain the criterion via an RRC message received from the network entity.
Aspect 14: The wireless communication device of any of aspects 1 through 13, wherein in response to receiving an indication to deactivate the QoE configuration from the network entity, the processor is further configured to release the QoE configuration.
Aspect 15: The wireless communication device of any of aspects 1 through 14, wherein the processor is configured to deactivate the QoE configuration in response to at least one of: expiration of a QoE configuration validity timer at the wireless communication device, or a determination, made at the wireless communication device, that the wireless communication device has moved outside of a predetermined QoE area scope.
Aspect 16: A method of wireless communication at a wireless communication device, comprising: activating a quality of experience (QoE) configuration, accumulating QoE data in a buffer while in a radio resource control (RRC) inactive state or an RRC_IDLE state subsequent to activating the QoE configuration, deactivating the QoE configuration, initiating an RRC connection setup procedure, from the RRC_IDLE state, or an RRC connection resume procedure, from the RRC_INACTIVE state, in response to both having the QoE data in the buffer and the deactivating the QoE configuration, and sending the QoE data in the buffer to a network entity following entry into an RRC_CONNECTED state at a conclusion of the RRC connection setup procedure or the RRC connection resume procedure.
Aspect 17: The method of aspect 16, further comprising: stopping the accumulating of the QoE data in response to determining to deactivate the QoE configuration, and storing parameters of the QoE configuration.
Aspect 18: The method of aspect 16 or 17, further comprising: conveying an indication, from an RRC layer to an application layer of the wireless communication device, to suspend QoE measurements.
Aspect 19: The method of any of aspects 16 through 18, further comprising: starting a timer in response to the deactivating the QoE configuration, and deleting the QoE configuration and corresponding QoE data in the buffer in response to expiration of the timer.
Aspect 20: The method of any of aspects 16 through 19, further comprising: starting a timer in response to the deactivating the QoE configuration, accumulating new QoE data in the buffer while in a new RRC_INACTIVE state or a new RRC_IDLE state, and, in response to an expiration of the timer: releasing the QoE configuration and QoE data in the buffer, or initiating a new RRC connection setup procedure, from the new RRC_IDLE state, or a new RRC connection resume procedure, from the new RRC_INACTIVE state, in response to both having the new QoE data in the buffer and the additional deactivation of the QoE configuration, and sending the new QoE data in the buffer to the network entity following entry into a new RRC_CONNECTED state at a conclusion of the new RRC connection setup procedure or the new RRC connection resume procedure.
Aspect 21: The method of any of aspects 16 through 20, further comprising: re-activating the QoE configuration in accordance with the stored parameters of the QoE configuration in response to: determining, at the wireless communication device, that the wireless communication device has moved inside of a predetermined QoE area scope after having been outside of the predetermined QoE area scope, or receiving an indication, from the network entity, to re-activate the QoE configuration upon entering a new RRC_CONNECTED state.
Aspect 22: The method of any of aspects 16 through 21, further comprising: obtaining criterion utilized to determine whether to initiate the RRC connection setup procedure or the RRC connection resume procedure.
Aspect 23: The method of aspect 22, wherein the criterion are configured to the wireless communication device or are preconfigured in the wireless communication device.
Aspect 24: The method of any of aspects 16 through 23, wherein the criterion includes at least one of: a first threshold against which an amount of the QoE data in the buffer is compared, a second threshold against which an elapsed time since a start of QoE data measurement or a start of the accumulating of the QoE data in the buffer is compared, or receipt of QoE data associated with QoE information in a predetermined set of QoE information, and satisfying any one or more of the criterion causes the wireless communication device to initiate the RRC connection setup procedure or the RRC connection resume procedure.
Aspect 25: The method of aspect 24, wherein the predetermined set of QoE information includes at least one of: a service type, slice scope, QoE reference, multicast and broadcast service (MBS) sessions, or QoE configuration RRC identifier.
Aspect 26: The method of any of aspects 16 through 25, wherein the criterion is configured to an RRC layer of the wireless communication device, and further comprising: obtaining, by the RRC layer, the criterion, and utilizing, by the RRC layer, the criterion to determine whether to initiate the RRC connection setup procedure or the RRC connection resume procedure.
Aspect 27: The method of any of aspects 16 through 26, wherein the criterion is configured to an application layer of the wireless communication device, and further comprising: obtaining, by the application layer, the criterion, and utilizing, by the application layer, the criterion to determine whether to deliver the QoE data in the buffer to an RRC layer of the wireless communication device.
Aspect 28: The method of any of aspects 16 through 27, wherein the wireless communication device obtains the criterion via an RRC message received from the network entity.
Aspect 29: The method of any of aspects 16 through 28, wherein in response to receiving an indication to deactivate the QoE configuration from the network entity, the wireless communication device releases the QoE configuration.
Aspect 30: The method of any of aspects 16 through 29, wherein the deactivating the QoE configuration occurs in response to at least one of: expiration of a QoE configuration validity timer at the wireless communication device, or a determination, made at the wireless communication device, that the wireless communication device has moved outside of a predetermined QoE area scope.
Aspect 31: The method of any of aspects 16 through 30, wherein the RRC connection resume procedure includes an initiation of a small data transmission (SDT) during the RRC_INACTIVE state, the SDT being utilized to send the QoE data in the buffer to the network entity.
Aspect 32: The wireless communication device of any of aspects 1 through 15, wherein the RRC connection resume procedure includes an initiation of a small data transmission (SDT) during the RRC_INACTIVE state, the SDT being utilized to send the QoE data in the buffer to the network entity.
Aspect 33: An apparatus configured for wireless communication comprising at least one means for performing a method of any one of aspects 16 through 31.
Aspect 34: A non-transitory computer-readable medium having stored therein instructions executable by one or more processors of a base station to perform a method of any one of aspects 16-31.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA 2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-13 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1-13 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein. While some examples illustrated herein depict only time and frequency domains, additional domains such as a spatial domain are also contemplated in this disclosure.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. The construct A and/or B is intended to cover: A; B; and A and B. The word “obtain” as used herein may mean, for example, acquire, calculate, construct, derive, determine, receive, and/or retrieve. The preceding list is exemplary and not limiting. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

1. A wireless communication device, comprising:
a memory; and
a processor coupled to the memory, the processor being configured to:
activate a quality of experience (QoE) configuration;
accumulate QoE data in a buffer while in a radio resource control inactive (RRC_INACTIVE) state or an RRC_IDLE state subsequent to activating the QoE configuration;
deactivate the QoE configuration;
initiate an RRC connection setup procedure, from the RRC_IDLE state, or an RRC connection resume procedure, from the RRC_INACTIVE state, in response to both having the QoE data in the buffer and the deactivate the QoE configuration; and
send the QoE data in the buffer to a network entity following entry into an RRC_CONNECTED state at a conclusion of the RRC connection setup procedure or the RRC connection resume procedure.

2. The wireless communication device of claim 1, wherein the processor is further configured to:
stop the accumulating of the QoE data in response to determining to deactivate the QoE configuration; and
store parameters of the QoE configuration.

3. The wireless communication device of claim 2, wherein the processor is further configured to:
convey an indication, from an RRC layer to an application layer of the wireless communication device, to suspend QoE measurements.

4. The wireless communication device of claim 2, wherein the processor is further configured to:
start a timer in response to the deactivating the QoE configuration; and
delete the QoE configuration and corresponding QoE data in the buffer in response to expiration of the timer.

5. The wireless communication device of claim 2, wherein the processor is further configured to:
start a timer in response to the deactivating the QoE configuration;
accumulate new QoE data in the buffer while in a new RRC_INACTIVE state or a new RRC_IDLE state; and;
in response to an expiration of the timer:
release the QoE configuration and the new QoE data in the buffer, or
initiate a new RRC connection setup procedure, from the new RRC_IDLE state, or a new RRC connection resume procedure, from the new RRC_INACTIVE state, in response to both having the new QoE data in the buffer and an additional deactivation of the QoE configuration, and
send the new QoE data in the buffer to the network entity following entry into a new RRC_CONNECTED state at a conclusion of the new RRC connection setup procedure or the new RRC connection resume procedure.

6. The wireless communication device of claim 2, wherein the processor is further configured to:
re-activate the QoE configuration in accordance with the stored parameters of the QoE configuration in response to the processor being configured to:
determine, at the wireless communication device, that the wireless communication device has moved inside of a predetermined QoE area scope after having been outside of the predetermined QoE area scope, or
receive an indication, from the network entity, to re-activate the QoE configuration upon entering a new RRC_CONNECTED state.

7. The wireless communication device of claim 1, wherein the processor is further configured to:
obtain criterion utilized to determine whether to initiate the RRC connection setup procedure or the RRC connection resume procedure.

8. The wireless communication device of claim 7, wherein the criterion are configured to the wireless communication device or are preconfigured in the wireless communication device.

9. The wireless communication device of claim 7, wherein the criterion includes at least one of:
a first threshold against which an amount of the QoE data in the buffer is compared,
a second threshold against which an elapsed time since a start of QoE data measurement or a start of the accumulating of the QoE data in the buffer is compared, or
receipt of QoE data associated with QoE information in a predetermined set of QoE information, and
satisfying any one or more of the criterion further configures the processor to initiate the RRC connection setup procedure or the RRC connection resume procedure.

10. The wireless communication device of claim 9, wherein the predetermined set of QoE information includes at least one of: a service type, slice scope, QoE reference, multicast and broadcast service (MBS) sessions, or QoE configuration RRC identifier.

11. The wireless communication device of claim 7, wherein the criterion is configured to an RRC layer of the wireless communication device, and the processor is further configured to:
obtain, by the RRC layer, the criterion; and
utilize, by the RRC layer, the criterion to determine whether to initiate the RRC connection setup procedure or the RRC connection resume procedure.

12. The wireless communication device of claim 7, wherein the criterion is configured to an application layer of the wireless communication device, and the processor is further configured to:
obtain, by the application layer, the criterion; and
utilize, by the application layer, the criterion to determine whether to deliver the QoE data in the buffer to an RRC layer of the wireless communication device.

13. The wireless communication device of claim 7, wherein the processor is configured to obtain the criterion via an RRC message received from the network entity.

14. The wireless communication device of claim 1, wherein in response to receiving an indication to deactivate the QoE configuration from the network entity, the processor is further configured to release the QoE configuration.

15. The wireless communication device of claim 1, wherein the processor is configured to deactivate the QoE configuration in response to at least one of:
expiration of a QoE configuration validity timer at the wireless communication device, or
a determination, made at the wireless communication device, that the wireless communication device has moved outside of a predetermined QoE area scope.

16. A method of wireless communication at a wireless communication device, comprising:
activating a quality of experience (QoE) configuration;
accumulating QoE data in a buffer while in a radio resource control inactive (RRC_INACTIVE) state or an RRC_IDLE state subsequent to activating the QoE configuration;
deactivating the QoE configuration;
initiating an RRC connection setup procedure, from the RRC_IDLE state, or an RRC connection resume procedure, from the RRC_INACTIVE state, in response to both having the QoE data in the buffer and the deactivating the QoE configuration; and
sending the QoE data in the buffer to a network entity following entry into an RRC_CONNECTED state at a conclusion of the RRC connection setup procedure or the RRC connection resume procedure.

17. The method of claim 16, further comprising:
stopping the accumulating of the QoE data in response to determining to deactivate the QoE configuration; and
storing parameters of the QoE configuration.

18. The method of claim 17, further comprising:
conveying an indication, from an RRC layer to an application layer of the wireless communication device, to suspend QoE measurements.

19. The method of claim 17, further comprising:
starting a timer in response to the deactivating the QoE configuration; and
deleting the QoE configuration and corresponding QoE data in the buffer in response to expiration of the timer.

20. The method of claim 17, further comprising:
starting a timer in response to the deactivating the QoE configuration;
accumulating new QoE data in the buffer while in a new RRC_INACTIVE state or a new RRC_IDLE state; and;
in response to an expiration of the timer:
releasing the QoE configuration and the new QoE data in the buffer, or
initiating a new RRC connection setup procedure, from the new RRC_IDLE state, or a new RRC connection resume procedure, from the new RRC_INACTIVE state, in response to both having the new QoE data in the buffer and the additional deactivation of the QoE configuration, and
sending the new QoE data in the buffer to the network entity following entry into a new RRC_CONNECTED state at a conclusion of the new RRC connection setup procedure or the new RRC connection resume procedure.

21-30. (canceled)
